(19) United States
(12) Patent Application Publication
(10) Pub. No.: US 2021/0012608 A1
(43) Pub. Date: Jan. 14, 2021

(54) GAMING SYSTEM AND METHOD HAVING A CLUSTER PATTERN GAME

(71) Applicant: ADP GAUSELMANN GMBH, Espelkamp (DE)

(72) Inventors: Jeffrey Stewart Chadwell, Las Vegas, NV (US); Joshua Matthew Lynn, Las Vegas, NV (US)

(21) Appl. No.: 16/510,580

(22) Filed: Jul. 12, 2019

(51) Int. Cl. G07F 17/32

(52) U.S. Cl. CPC G07F 17/3213; G07F 17/3244

(57) ABSTRACT

A gaming system and a related method provide a game that includes symbol display areas and one or more cluster patterns that can be associated with two or more of the symbol display areas to create a winning outcome and one or more awards. The gaming system includes one or more symbol sets that provide symbols displayed in the symbol display areas, and a cluster pattern may be associated with a grouping of one or more of the symbol display areas. Cluster patterns of different sizes and shapes, or multiple similar shaped and sized cluster patterns positioned in different locations may be used. The gaming system evaluates symbols displayed in a grouping of the symbol display areas associated with a cluster pattern to determine an award. The gaming system may further evaluate the symbol display areas to determine other awards associated with the displayed symbols.

### FIELD OF THE DISCLOSURE

The present disclosure relates to gaming devices.

### BACKGROUND

Gaming machines accept wagers from players in exchange for the opportunity to win awards or prizes. Current gaming machines use computing devices that control various technologies to provide specialized systems adapted to gain the attention of players and to keep them engaged with the gaming machines. To retain players' interest, gaming machines that offer new and unconventional functionality are needed.

### SUMMARY

Various implementations of a gaming system and a related method provide a game that includes symbol display areas and one or more cluster patterns that can be associated with one or more of the symbol display areas to create one or more awards. A cluster pattern can be any suitable shape, such as a square, rectangle, circle, triangle, trapezoid, polymino, etc. The gaming system may include one or more symbol sets that provide symbols for display in the symbol display areas. In some implementations, groups of the symbol display areas may be associated with different symbol sets. In some implementations, the gaming system may select a cluster pattern for association with a grouping of the symbol display areas. In some implementations, the gaming system may determine a position of a cluster pattern in the symbol display areas based on a random positioning of the cluster pattern, the wager amount, the number of pay lines activated in the base game, etc. The gaming system may evaluate displayed symbols in the symbol display areas and within the cluster pattern for one or more winning symbol combinations. The gaming system may provide an award based on such winning symbol combinations.

In some implementations, the gaming system may provide a visual indication of a cluster pattern as applied to the association or grouping of the symbol display areas. In some implementations, the gaming system may display a border around the grouping of the symbol display areas to form a representation of the cluster pattern. In some implementations, the gaming system may modify a visual characteristic (e.g., size, brightness, color, etc.) of the displayed symbols associated with the cluster pattern.

In some implementations, the gaming system may evaluate the grouping of the symbol display areas associated with the cluster pattern (e.g., determine an award associated with the combination of displayed symbols in the cluster pattern within the symbol display areas), and issue the player an award determined for the cluster pattern game feature. In some implementations, the gaming system may evaluate the displayed symbols associated with the cluster pattern for the presence of one or more winning symbols or winning symbol combinations, and determine an award associated with the winning symbols or winning symbol combinations. For example, the gaming system may determine that the player receives an award when at least a threshold quantity (e.g., one or more) or at least a threshold percentage (e.g., at least half) of the symbol display areas within the cluster pattern display a common symbol. In some implementations, the gaming system may determine an award based on this common symbol, a quantity of common symbols displayed in the grouping of the symbol display areas associated with the cluster pattern, etc. In some implementations, the gaming system may determine that a progressive award is triggered when the symbol display areas associated with the cluster pattern display one or more winning symbols or a particular winning symbol combination (e.g., the symbol display areas of the cluster pattern display an Ace symbol). In some implementations, the awards for the cluster patterns may be determined based on the wager amount, the number of pay lines activated, number of matching symbols, etc.

In some implementations, the gaming system may select the cluster pattern from a set of cluster patterns (e.g., cluster patterns that group respective subsets of the symbol display areas into different shapes, size, etc.). In some implementations, the gaming system may display the set of cluster patterns, such as displaying the set of cluster patterns in a first display region, and the symbol display areas in a second display region. In some implementations, the gaming system may select a cluster pattern from the set of cluster patterns based on an input received from the player and/or based on a wager amount, the number of pay lines activated, etc. In some implementations, the gaming system may associate the set of cluster patterns with respective different possible awards. For example, the gaming system may determine awards for the set of cluster patterns based on their respective sizes (e.g., quantities of symbol display areas grouped by the cluster patterns), respective shapes, etc.

In some implementations, the gaming system may provide multiple cluster patterns that are associated with respective groupings of the symbol display areas. The multiple cluster patterns can be different cluster patterns and/or may include one or more of a same cluster pattern. In some implementations, the gaming system may position the multiple cluster patterns such that the respective groupings of the symbol display areas associated with the multiple cluster patterns do not overlap each other. In some implementations, the gaming system may determine positions of the cluster patterns in the symbol display areas based on a random positioning of the cluster patterns or based on another factor, such as the wager amount, an input from the player, etc.

In some implementations, in addition to or as an alternative to awards based on cluster patterns, the gaming system may also determine awards based on winning symbols or winning symbol combinations not based on cluster patterns. For example, the gaming system may determine winning symbol combinations based on pay lines, scatter pays, ways pays, etc. In some implementations, the gaming system may include pay lines corresponding to various combinations of the symbol display areas. A player or gaming system may selectively activate one or more of the pay lines by placing wagers on such pay lines. For example, selecting a minimum wager amount may activate one pay line or more pay lines, selecting higher wager amounts may activate additional pay lines (and/or increase wagers on pay lines), and selecting a maximum wager amount may activate all pay lines (and/or place maximum wagers on all pay lines). The gaming system may evaluate the displayed symbols associated with the pay lines (e.g., determine an award associated with the combination of symbols displayed in subsets of the symbol display areas associated with the pay lines), and issue the player awards determined based on the active pay lines. The gaming system may issue both awards for the pay lines and awards for the cluster pattern.

In some implementations of a gaming system with one or more cluster patterns, the gaming system provides the cluster patterns in a bonus game. In some implementations, the gaming system may receive an indication from a bonus controller to initiate the bonus game. In some implementations, the gaming system may evaluate the displayed symbols in a base game to identify triggering symbol combinations and determine whether to trigger the bonus game with the cluster pattern game feature based on the triggering symbol combinations along wagered pay lines. For example, the gaming system may evaluate the displayed symbols of the base game for the presence of one or more symbols or symbol combinations that trigger the cluster pattern game feature. In some implementations, the gaming system may designate at least one symbol from the symbol sets as a triggering symbol. When the gaming system determines that at least a predetermined quantity of triggering symbols (e.g., one or more triggering symbols) are displayed in the symbol display areas, the gaming system may determine that the cluster pattern game feature is triggered. In some implementations, the gaming system may select the cluster pattern from multiple different cluster pattern candidates and/or a position of the cluster pattern at least partially based on evaluating the displayed symbols for the triggering symbol combinations (e.g., selecting the cluster pattern based on the displayed quantity of triggering symbols).

In some implementations, the gaming system may associate the symbol display areas with video-based slot machine reels (also herein referred to as “reels”). For example, the gaming system may provide a base game that includes multiple reels that are each associated with a determined number of symbol display areas. The gaming system may further include symbol sets that provide symbols associated with the reels. In some implementations, the reels are associated with different symbol sets. Furthermore, the gaming system may include pay lines corresponding to various combinations of reels.

As described above and set forth in greater detail below, gaming systems in accordance with aspects of the present disclosure provide a specialized computing device including non-conventional hardware and software that improve upon the existing technology of human-computer interfaces by providing functionality of generating display outputs that enable players to enjoy different games and generate new awards. Doing so improves the operation of the gaming systems for their specialized purpose by reducing player disappointment with game outcomes and enhancing player excitement for plays of a game.

### BRIEF DESCRIPTION OF THE DRAWINGS

FIG. 1 shows a perspective view illustrating an example gaming system in accordance with aspects of the present disclosure.

FIG. 2 shows a functional block diagram illustrating a gaming system in accordance with aspects of the present disclosure.

FIGS. 3A and 3B show process flow diagrams illustrating an example method of operating the gaming system that provides a cluster pattern game in accordance with aspects of the present disclosure.

FIGS. 4A-4F show screen shots of an implementation of a gaming system display illustrating an example of a cluster pattern game in accordance with aspects of the present disclosure.

FIGS. 5A and 5B show screen shots of an implementation of a gaming system display illustrating an example of a cluster pattern game in accordance with aspects of the present disclosure.

### DETAILED DESCRIPTION

Various implementations of gaming systems and methods consistent with the present disclosure provide a gaming system that includes symbol display areas and one or more cluster patterns that can be associated with two or more of the symbol display areas to create one or more awards. The gaming system may generate symbols displayed in the symbol display areas using one or more symbol sets. The gaming system may associate the cluster pattern with a grouping of the symbol display areas and may evaluate the grouping of the symbol display areas associated with the cluster pattern (e.g., determine an award associated with the combination of displayed symbols in the cluster pattern within the symbol display areas), and issue the player an award determined for the cluster pattern. The gaming system may provide multiple cluster patterns that are associated with respective groupings of the symbol display areas, and the multiple cluster patterns may be different cluster patterns and/or may include two or more of a same cluster pattern. The cluster pattern may be selected from a set of different cluster patterns of different shape and/or grouping a different quantity of the symbol display areas. The gaming system may also evaluate the displayed symbols and/or various combinations of the displayed symbols (e.g., determine an award associated with the combination of symbols for winning combinations displayed in subsets of the symbol display areas associated with the pay lines), and issue the player one or more awards determined based on the displayed symbols in addition to or alternative to awards associated with the cluster patterns.

In some implementations, a gaming system includes a cabinet, a processor, a display device supported by the cabinet, an input device supported by the cabinet, a value acceptor supported by the cabinet, a value dispenser supported by the cabinet, and a memory device that stores program instructions. The program instructions, when executed by the processor, control the gaming device to perform operations including establishing a credit balance based at least in part on a monetary value received by the value acceptor. The operations can also include placing a wager following receipt of a wager input via the input device, the credit balance being decreased by the wager. The operations can also include randomly generating symbols from symbol sets and displaying, on the display device, the generated symbols in a number of symbol display areas, whereby the symbol display areas may be arranged in columns of symbol display areas. The operations can include determining a cluster pattern that is associated with a grouping of the symbol display areas, and evaluating the displayed symbols for the grouping of the symbol display areas associated with the cluster pattern for a winning symbol combination. The operations can include evaluating various other combinations of the displayed symbols (e.g., pay lines) for winning symbol combinations. In another example the operations can also include evaluating the displayed symbols for symbol combinations that initially trigger the cluster pattern feature. The operations can further include displaying, on the display device, an award based on any winning symbol combinations for the grouping of the symbol display areas associated with the cluster pattern or other combinations of the displayed symbols independent of the cluster pattern, the credit balance being increased by the award, and issuing value from a value dispenser based on the credit balance upon receipt of a cash out request or signal via an input device.

### Gaming Device Platform

The features and advantages of the gaming system and method described herein may be provided to a player via a gaming device platform that includes various structures and components for allowing player interaction with the gaming device. While only one gaming device platform will be described in detail herein, it is understood that the features, objects, and advantages of the gaming system described herein may be implemented in one or more alternative gaming device platforms.

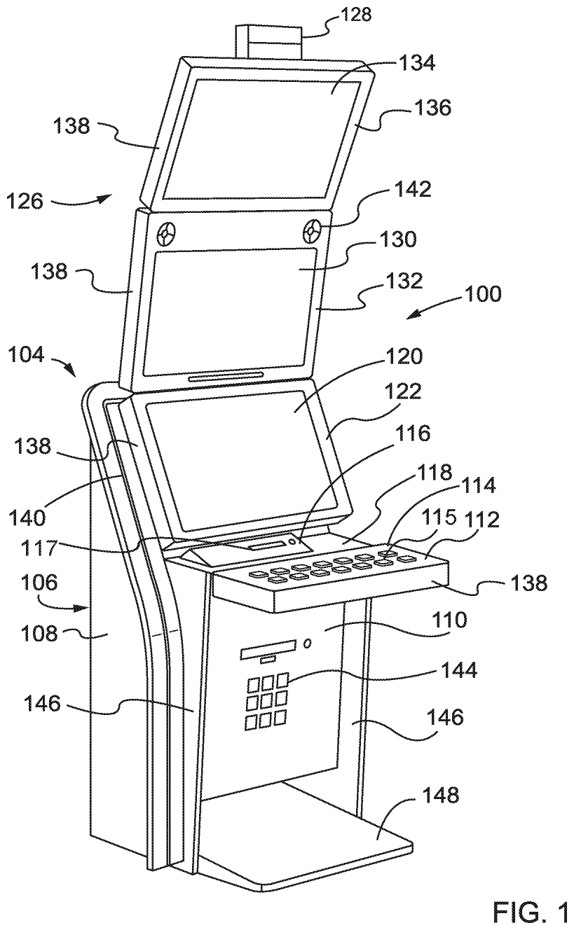

FIG. 1 shows a perspective view illustrating an example of gaming system 100 in accordance with aspects of the present disclosure. Such gaming system 100 may be referred to as a slot machine and, as illustrated, is housed in a cabinet 104 (e.g., a housing) constructed so that a player can operate and play the gaming system 100 while standing or sitting. The cabinet 104 can include a lower cabinet body portion 106, which includes a pair of cabinet side panels 108 (only one of which is viewable in the perspective view of FIG. 1), a front panel 110, and a rear panel (not shown). Additionally, a base panel (not shown) and a top panel surface (not shown) may support a first game display device 120 and the player interaction area 112. The cabinet panels 104, 106, 108, 110 (as well as the base panel and the top panel surface) may be interconnected along their edges and cooperate to form the cabinet 104, which encloses and houses components of the gaming system 100, as can be seen in FIG. 1. The cabinet 104 may function to securely protect local control system, technology components, and provide support for game display(s) and player input and output interactions with the gaming system 100, such as describe herein below.

While the example cabinet 104 is depicted as having a particular shape, structure, and organization, it should be appreciated that a wide variety of cabinet enclosure sizes, shapes, and designs are possible for the gaming system 100. For example, the cabinet panels 104, 106, 108, 110 (as well as the base panel and the top panel surface) may be combined into fewer elements or divided into additional elements. Additionally, the positions of the displays (e.g., first display device 120) and input/output devices can be reorganized and/or relocated with respect to one another.

In accordance with aspects of the present disclosure, a player can interact with the gaming system 100 in various ways to direct the wagering and game play activities and preferences. More specifically, the cabinet 104 includes input and output areas generally designated as the player interaction area 112. The player interaction area 112 may be located on the front top side of cabinet 104 and, as shown, on a panel structure that extends outwardly from the gaming system 100 in a player's direction. The player interaction area 112 may contain player input and output structures, including a player control area 114, a player value acceptor and dispenser area 116, and player convenience input area 118.

The player control area 114 includes one or more input devices 115, such as buttons or touch sensitive areas, through with which players may interact with the gaming system 100 so as to direct game play. It is expected that the cabinet 104 provides an easily accessible location and support for player input/output (I/O) interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control interactions could be made by either the physical controls or functionally equivalent “soft” controls (e.g., soft buttons) located on the gaming display and activated by player touch (e.g., touch screen interfaces), or a combination of both arrangements.

The input devices 115 may include the following: game selection button(s) in any implementation where more than one game is provided in a single gaming system 100; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information.

The player value acceptor and dispenser area 116 may include one or more value acceptance and value distribution devices 117 that allow the player to interact with the gaming system 100 and to risk or otherwise place a wager (a monetary value) on one or more outcomes of a game. The value acceptance and value distribution devices 117 may return winnings to the player via some form of value distribution. In the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

Upon receipt of some type of value from the player, the value acceptance and value distribution devices 117 of the player value acceptor and dispenser area 116 can perform validation on the player supplied value using appropriate hardware readers (e.g., determining that the currency bills/coins/tokens are genuine or the ticket/voucher is genuine). If the validation result is positive on player supplied value, the value acceptance and value distribution devices 117 can generate a signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device or converted to currency at a conveniently located kiosk or cashier counter located near the gaming device. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin).

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, a numeric or alphanumeric keypad (not shown) may be provided adjacent to the card reader slot that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/player tracking cards may be associated with a player account and are utilized by the card-issuing entity to monitor or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more universal serial bus (USB) ports that enables a player to charge their electronics or connect to services such as the Internet or food service. Further, player convenience input area 118 of the gaming system 100 may include buttons to request food or drink service if the gaming device is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of input locations on the cabinet 104 may be dependent upon the game buttons, the type of value wagered, and the player conveniences utilized in the deployment configuration of gaming system 100.

With continuing reference to FIG. 1, in some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be used in any suitable orientation. In the illustrated implementation, the first game display device 120 can mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. In some implementations, the gaming system 100 may use a single first game display device 120 and not include additional game displays (not illustrated). For example, a single first game display 120 may span the one or more portions of the cabinet 104 (e.g., lower body cabinet portion 106 and upper body cabinet body portion 126, described below) in place of other display devices (e.g., display devices 130 and 134, described below).

The lower cabinet body portion 106 can be further constructed to support an upper cabinet portion 126. The upper cabinet portion 126 may be comprised of an upwardly extending support structure (not illustrated) that extends upwardly from the rear side of lower cabinet body portion 106 configured to mechanically support one or more additional game displays.

At the topmost end of the support structure, a cabinet top light 128 may be provided. The cabinet top light 128 is capable of illumination in a variety of colors and is utilized to indicate and communicate conditions of the gaming system 100 to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 100 includes additional displays, including a second game display device 130 and a third game display device 134. The second game display device 130 and the third game display device 134 can be disposed generally in a vertical relationship and generally in alignment with the first game display device 120. Like the first game display device 120, the second game display device 130 and the third game display device 134 can be 27-inch LCD displays and can be mounted in a widescreen orientation in some implementations. However, any suitable display in any suitable orientation may be used for the second game display device 130 and the third game display device 134. Further, like the first game display device 120, the second game display device 130 and the third game display device 134 can be mounted within and framed by second display frame 132 and third display frame 136, respectively. The second display frame 132 and the third display frame 136 can be attached to the upper cabinet support structure and can protect the second game display device 130 and the third game display device 134.

The first game display device 120, the second game display device 130, and the third game display device 134 can be disposed at an angle from each other to form a player-facing concave arc. However, in some implementations, the angles between the displays 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming device. Equivalent display devices include all variations of liquid crystal displays, light emitting diode displays, and plasma displays.

In some implementations, different sized displays may be combined to display gaming data on gaming system 100. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with the game.

In some implementations, the curved displays may be used for any or all of the first game display device 120, the second game display device 130, or the third game display device 134. Similarly, any of the displays used for gaming system 100 can be based on flexible display technologies. For example, it is possible to utilize flexible display technologies to create uniquely shaped curving, wavy, or tubular display structures to provide one or more of the first game display device 120, the second game display device 130, and the third game display device 134. Additionally, in some implementations flexible display technologies can be used in combination with fixed flat screen technologies.

While the gaming system 100 has been described as implemented with video technologies, in some implementations, mechanical reels with reel strips containing game indicia and step motor controllers may be employed to provide game information to a player. In some implementations, the reel strips may include printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming device housing style, a variety of other display technologies may be utilized in combination with the gaming device disclosed herein. For example, the gaming system 100 may have one or more display devices in addition to the base game display(s) in some implementations. For example, the gaming system 100 may include a player tracking device having a player tracking display which displays various information to the player regarding the player's status. The gaming system 100 may also include other game-related displays such as the wager display and the gaming credit balance display. These additional game-related displays may be separate display devices or may be displayed on any one or more of the first game display device 120, the second game display device 130, or the third game display device 134.

The gaming system 100 may also include cabinet lighting design functions to attract players. In the example gaming system 100 illustrated in FIG. 1, attractive cabinet lighting is provided by frame accent lighting 138. It is noted that frame accent lighting 138 is a common structure found on the first display frame 122, the second display frame 132, and the third display frame 136 and player interaction area 112. Example areas where frame accent lighting is applied to the gaming system 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In some implementations, the circuit boards are flexible circuit boards. These LED strips and transparent or translucent coverings may surround one or more gaming device displays frames, as well as the player interaction area, to highlight these areas.

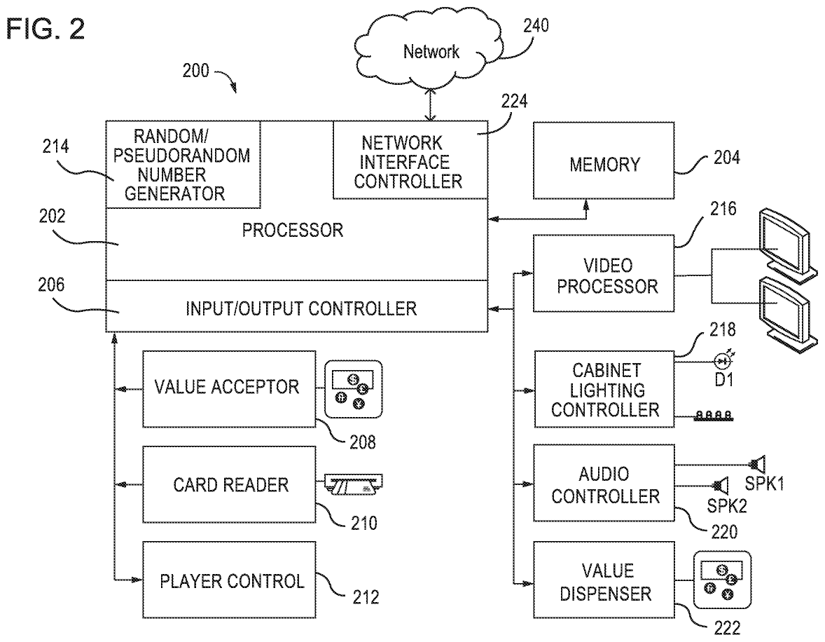

In some implementations, the individual LEDs mounted on the LED strips are of a type that can emit red, green, and blue light. In an alternative implementation, separate LEDs are used for the light colors. All LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other variations are possible.

In some implementations, cabinet 104 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, cabinet 104 includes cabinet accent lighting 140. In some implementations, cabinet accent lighting 140 is LED rope lighting mounted flush with the front side edge of the cabinet side panels 108. The LED rope lighting can generate any of suitable colors and are controlled by cabinet lighting controller and a processor of gaming system 100 to selectively mix the emitted light colors in a manner to create any color in the same manner as the frame edge lighting.

In various implementations, gaming system 100 includes one or more audio speakers 142 and appropriate driving electronics and sound cards so that game players may experience pleasing audio aspects of the gaming system 100. Audio is desirable to attract and maintain player interest in gaming system 100. The gaming system 100 may also emit attraction sounds during any idle period of gaming system 100. Game audio may add to the player's enjoyment of gaming system 100 by providing music and sound effects designed to enhance and compliment the gaming experience. In FIG. 1, the audio speakers 142 are shown mounted on the upper corners of second display frame 132. Any suitable number of additional speakers 142 may be provided on additional display frames or on the lower cabinet body portion 106 as desired.

The speakers 142 designed for emitting bass vibrations may be included in some implementations. Placement of the speakers 142 may be selected to enhance the sound emitting characteristics of the gaming system 100. For example, bass speakers or additional speakers 144 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and also to block out noise from other gaming devices.

In some implementations, the front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing the gaming system 100 in a seated position. Foot rest 148, which may be cushioned, is provided below player interaction area 112 to enhance a player's ergonomic comfort while playing the gaming system 100. In some implementations, the edges of player interaction area 112 may be ergonomically cushioned as well.

The gaming system 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary, and/or 3) provide an easy location and support for all necessary player input/output (I/O) interactions, including gaming control interactions and value wagering interactions. For example, in some implementations the gaming system 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 104 of gaming system 100 may include bar top or table top housing arrangements. These housings are generally small enough to be placed on top of an existing bar or table while providing the requisite gaming device housing functions of protection of/access to gaming electronics, displays, and player I/O functions described above.

In some implementations, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 illustrates a functional block diagram of a control unit 200 of a gaming system (e.g., gaming system 100) configured to perform specialized game functions and operations, consistent with the embodiments described herein. The functional elements shown in FIG. 2 cooperate, on a broad and general level, to function as a gaming system. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In accordance with aspects of the present disclosure, the control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one implementation, the control unit 200 is also configured to communicate with a server device through a network.

In some implementations, the control unit 200 includes at least one processor 202 (e.g., a central processing unit (CPU)). In some implementations, the processor 202 is specially configured with arithmetic logic units and math co-processors, also known as floating point units, for performing the gaming consistent with the various implementations disclosed herein. In some implementations, the specially configured processor 202 includes registers for holding instructions or other data, and cache memory for storing data for faster operation thereupon. In some implementations, the specially configured processor 202 may be a multi-core processor that includes two or more processors for enhanced performance, more efficient parallel processing, or other advantageous computing functions. In another implementation, the specially configured processor 202 may be one or more processing devices such as microprocessor(s) or integrated circuit(s) and may include one or more controllers. It should be appreciated that in some implementations, a general-purpose processor could be programmed to perform the functions of the specially configured processor 202.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

At least one specially configured processor 202 or controller of control unit 200 may be specially configured to communicate with at least one memory device 204, generally shown as memory device 204 in FIG. 2. In some implementations, the memory device 204 includes one or more memory structures for storing instructions and various types of game data. The memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in some implementations, communication with the memory device 204 by the specially configured processor 202 or a controller, encompasses the processor or controller accessing the memory device 204, exchanging data with the memory device 204, or storing data to the memory device 204.

The memory device 204 may store all program code and game code (collectively the “code”), and operation data necessary for the operation of the control unit 200 providing a gaming device and execution of the gaming features described hereinbelow. In an alternative implementation, game code and operation data necessary for the operation of the control unit 200 may be stored in a distributed manner such that some code is stored in memory device 204 and other code is stored remotely from the control unit 200. In some implementations, the code and operation data necessary for the operation of the control unit 200 includes, for example, basic input and output function data, instruction fetching data, bus and network communication protocol data, and like data necessary for an operational gaming device. In some implementations, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in some implementations, the code and operation data for the operation of the gaming device described above may be stored in removable game cartridges or flash drives, a compact disk ROM, a digital versatile disk (DVD) optical storage technology, or suitable other fixed non-transitory storage mediums. In another implementation, part or all of the code and operational data for operation of the gaming device or for execution of the game features may be stored in a remote memory structure and be downloaded to the memory device 204 via a network connection.

In some implementations, the control unit 200 may utilize any combination of memory devices such as random access memory devices (RAMs), unalterable memory devices (ROMs), and mass storage devices for securely storing and securely communicating the software components or code that facilitate game play and other functions of the control unit 200. The memory devices may store software components or codes that include various game data and game related control and execution software. In some implementations, the software components stored in the memory devices 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the control unit 200.

In some implementations, memory devices, such as memory device 204, with the software components and other data may be secured and authenticated by authentication software stored in an unalterable memory device within the housing of the control unit 200. The control unit 200 may also include application specific integrated circuits (ASICs) to perform the security and authentication functions. At any appropriate time, such as before each play of a game, at a predetermined interval, upon transfer of any game data or any software components from a mass storage to the memory device 204, or upon demand, the control unit 200 (using a processor such as processor 202 or a separate ASIC) may execute an authentication routine and perform an authentication of any software component or other data of the control unit 200. In some implementations, the gaming device software components may be prepared for authentication via creation and storage of an encrypted signature unique to one or more of the software components.

In some implementations, an encrypted signature may be created by utilizing a hash function on a software component or code to form a message digest (i.e., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming device software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the control unit 200 may allow game play to proceed. However, when the message digests do not match, the control unit 200 may determine that the software component under authentication may be corrupted or fraudulent and game play may be halted. It should be appreciated that the control unit 200 may perform other suitable security and authentication checks on the game data or software components. Such authentication and security devices and functions are unique to gaming and casino industry to minimize or prevent fraud in gaming devices and gaming systems.

For a player to interact with a gaming device, the control unit 200 receives and processes player inputs, and the control unit 200 causes processed results to be output or communicated to the player. In some implementations, player inputs are recognized and processed or directed for processing by input/output (I/O) controller 206. Further, I/O controller 206 may process and direct player outputs for communication to the player. The I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for the attached input devices and output devices. In this manner, specially configured processor 202 is freed from the operational details of the peripheral I/O devices. For example, in some implementations where an input or output device is changed or upgraded, the I/O controller 206 can be changed without changing other gaming system components.

In some implementations, a player deposits value into a gaming device by inserting some form of currency into a value acceptor 208 for game play. Alternatively, a player deposits value into a gaming device by inserting an encoded paper ticket into a value acceptor 208 for game play in some implementations. The value acceptor 208 can be combined with a currency reader and validator, and a code reader for reading value encoded on paper tickets. The value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming system 100. During game play, the specially configured processor 202 processes a player's wagers and determines the amount of credits to debit from the player's credit balance. When a winning outcome is obtained, the specially configured processor 202 is configured to determine the amount of credits to add to the player's credit balance.

As previously mentioned with respect to FIG. 1, a variety of value acceptance arrangements are possible. In some implementations, the value acceptor 208 could include magnetic strip or chip card readers to accept and transfer value. The value acceptor 208 may also be configured to accept and transfer non-traditional currencies such as digital currencies. In these implementations, I/O controller 206, a specially configured processor 202, or both contain appropriate control instructions to communicate and extract value from the inserted item containing value. In some implementations, use of a magnetic strip or embedded chip card, for example a bank card, for value insertion requires the specially configured processor 202 to communicate, via network interface controller 224 (described below), with devices external to a gaming device.

In some implementations, a card reader 210 may be included in gaming system 100 to accept player loyalty cards. For example, card reader 210 can extract account identifying information from the card and utilizes this information to access the associated account information stored remotely via network interface controller 224. In implementations where player loyalty/player tracking systems are employed, a player's loyalty account and record of gaming activity can be stored in a networked storage location or database. The specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various implementations, a player control 212 receives a player's game inputs and communicates the player's game inputs to the specially configured processor 202. The player's game inputs may include, but are not limited to, wager amounts, pay line selections, game control signals, and cash-out signals. The player control 212 may generate signals based on button presses, touch screen activations, or voice control. The player-initiated signals are propagated to the specially configured processor 202 by the I/O controller 206. Further, the player-initiated signals may direct and inform execution of the game instructions stored in the memory device 204 and configured to be executed by the specially configured processor 202.

In some implementations, the specially configured processor 202 is configured to execute stored program code and instructions which generate random numbers or pseudo-random numbers. In some implementations, as illustrated in FIG. 2, a random number generator (RNG) 214 is a software module configured to be executed by the specially configured processor 202 for the generation of a true random or pseudo-random number. The code for RNG 214 may be stored in the memory device 204. The RNG 214 generates random numbers for use by the gaming software during game execution. In some implementations, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various implementations, once random symbols are selected based upon the random number generated by the RNG 214, patterns of symbols are compared to determine wagering outcomes. In an alternative implementation, gaming system 100 may include a hardware based random number generator that is in communication with specially configured processor 202 to supply random numbers for game generation purposes. The hardware based random number generator may be incorporated into specially configured processor 202 or can be separate from specially configured processor 202.

In yet another implementation, the random generation of “numbers” or symbols may be performed with electro-mechanical components. For example, gaming devices such as gaming system 100 may incorporate mechanical reels rotatable about a common axis. Indicia or symbols may be positioned around the periphery of the reels. The indicia or symbols on the reels may indicate separate detectable reel stop positions. The reels can be set into a spinning/rotation motion by pulling a lever or pushing a button. In some implementations, the gaming system 100 can stop the reels by a gaming device actuating, on a random timing basis, a suitable mechanical or electro-mechanical reel brake. When the reels stop rotating, one or more displayed stop positions of the reels are detected. Since the stop positions are associated with respective indicia or symbols, the gaming device can determine whether the combination of stop positions (i.e., translating to a combination of displayed symbols) results in a winning symbol combination.

Returning to FIG. 2, the control unit 200 controls the function and output of an output devices utilized by a gaming device. In various implementations, I/O controller 206 serves as an interface unit between specially configured processor 202 and output devices such as video processor 216, cabinet lighting controller 218, audio controller 220, and value dispenser 222.

In some implementations, the video processor 216 communicates with specially configured processor 202 to render all game graphics, video displays, and information on one or more video display units (e.g., displays 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video reels containing sets of gaming symbols.

It should be appreciated that in certain other implementations where physical mechanical reels are utilized by the gaming system 100 as a game displays, reel controllers and stepper motors would be provided in lieu of or in addition to video processor 216.

In implementations which utilize cabinet lighting as described with respect to FIG. 1, a cabinet lighting controller 218 may be utilized to coordinate and control the color and timing of cabinet lighting displays with specially configured processor 202. In certain implementations which utilize sound design, specially configured processor 202 may utilize audio controller 220 to coordinate and control the sound emissions. In some implementations, audio controller 220 may include one or more audio processing cards for generating sound and for driving the one, two or more speakers that may be included with a gaming device.

In various implementations, players may collect remaining credit value by initiating a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In some implementations, value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the specially configured processor 202 can direct the value dispenser 222 to issue to the player an appropriate amount of coin or bills directly to the player. Additionally, or alternatively, in some implementations, the player may have the option to electronically direct the credit value to an account associated with the player.

In some implementations, the control unit 200 may communicate with one or more devices outside the gaming device. For example, gaming system 100 may be connected to a larger network 240 via a local area network (LAN) or a wide area network (WAN). The control unit 200 may communicate with one or more central servers, controllers, or remote devices to execute games, establish credit balances, participate in jackpots, etc. In such implementations, network communications and connections are accomplished via a network interface controller 224. Network interface controller 224 can be a digital circuit board or card installed in control unit 200 to provide network communications with external devices.

In some implementations, various additional features and functions are performed by the control unit 200. For example, the control unit 200 may be specially configured with appropriate software to track all game play events that occur on a gaming device. In some implementations, the control unit 200 may audit all recorded monetary transactions, including all wager amounts, game outcomes, game winnings, and game payouts that occur through the value dispenser 222. Further, some implementations may include security software to assist in protecting the gaming system 100 from tamper or alteration attempts.

### Gaming System Operation

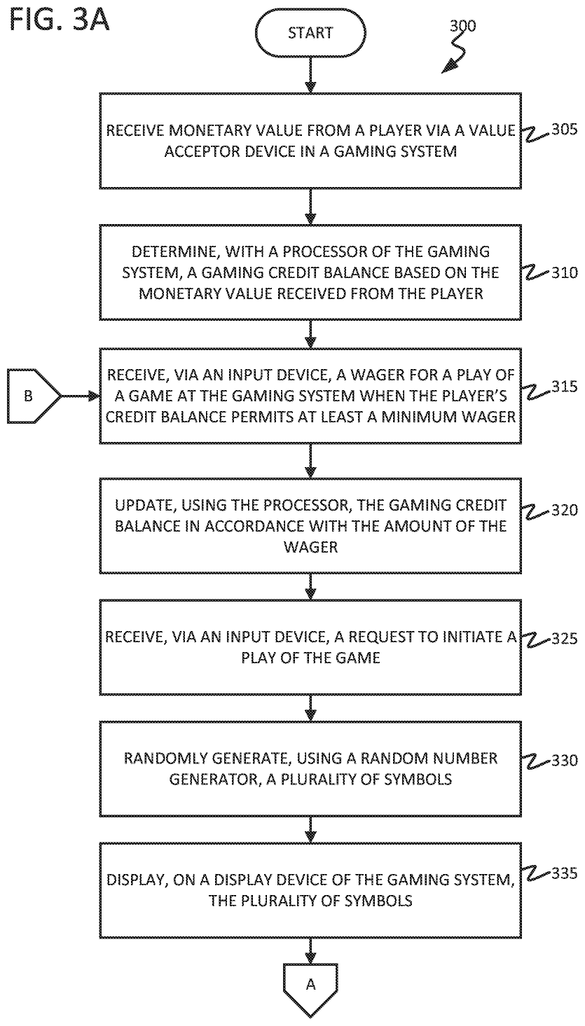

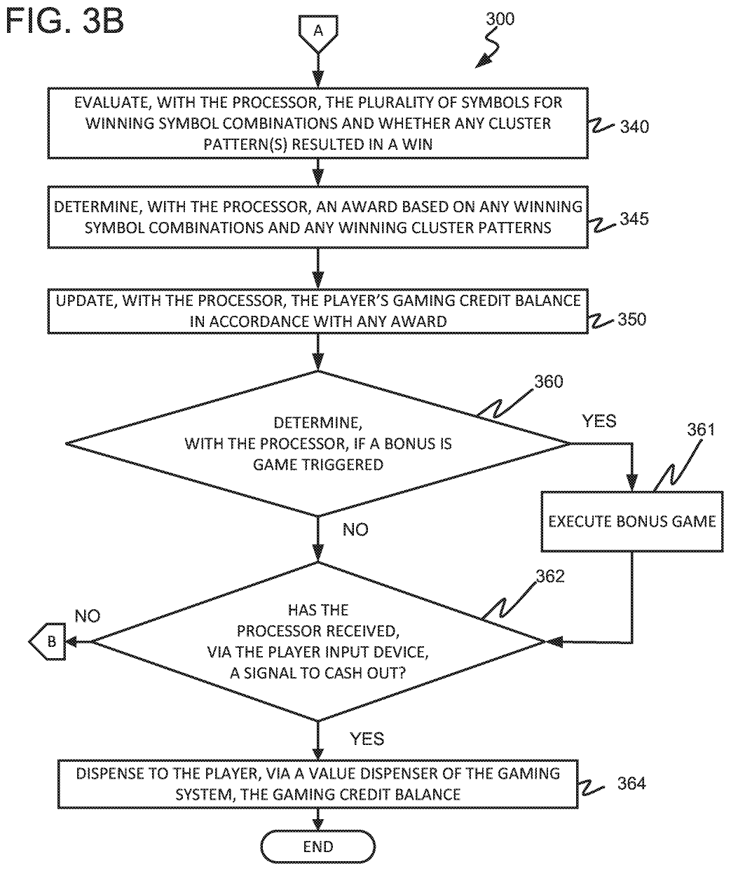

The flow diagrams in FIGS. 3A and 3B illustrate functionality and operation of possible implementations of systems, devices, methods, and computer program products according to various implementations of the present disclosure. Each block in the flow diagrams of FIGS. 3A and 3B can represent a module, segment, or portion of program instructions, which includes one or more computer executable instructions for implementing the illustrated functions and operations. In some alternative implementations, the functions and/or operations illustrated in a particular block of the flow diagram can occur out of the order shown in FIGS. 3A and 3B. For example, two blocks shown in succession can be executed substantially concurrently, or the blocks can sometimes be executed in the reverse order, depending upon the functionality involved. It will also be noted that each block of the flow diagram and combinations of blocks in the block diagram can be implemented by special purpose hardware-based systems that perform the specified functions or acts, or combinations of special purpose hardware and computer instructions. In some implementations, the flowcharts can include more blocks or fewer blocks.

FIGS. 3A and 3B show a process flow diagram illustrating an example of method 300 (also referred to herein as operation 300) of operating the gaming system (e.g., gaming system 100) providing a game that includes symbol display areas and one or more cluster patterns that can be associated with one or more of the symbol display areas to create one or more winning outcomes and lead to one or more awards, in accordance with aspects of the present disclosure.

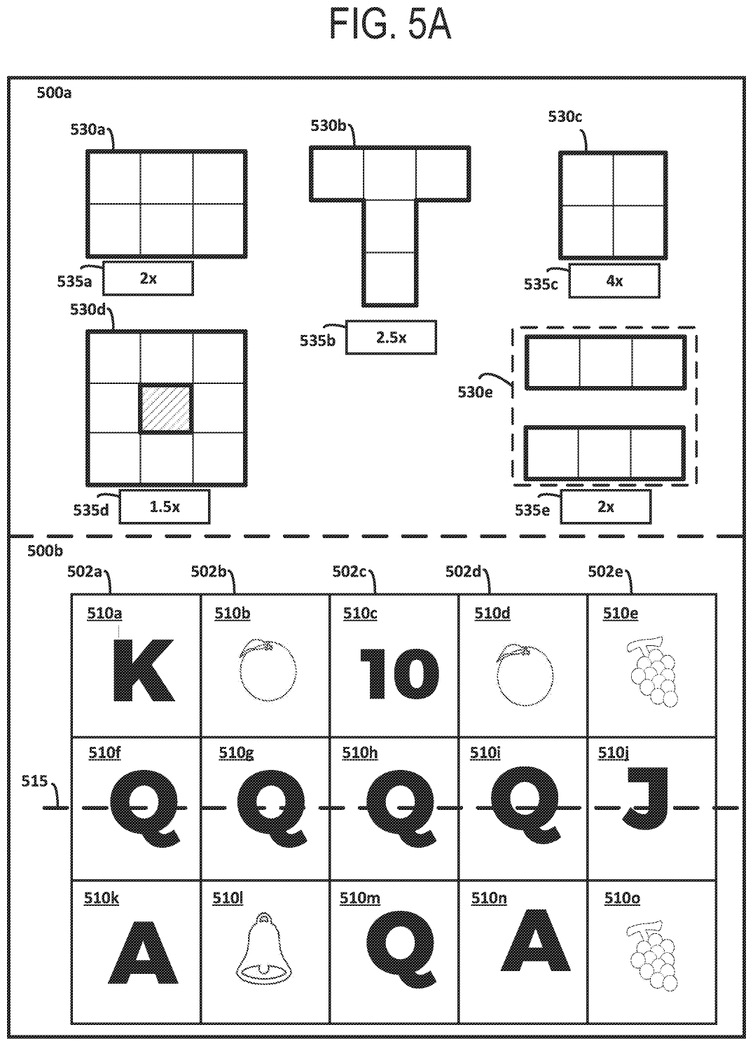

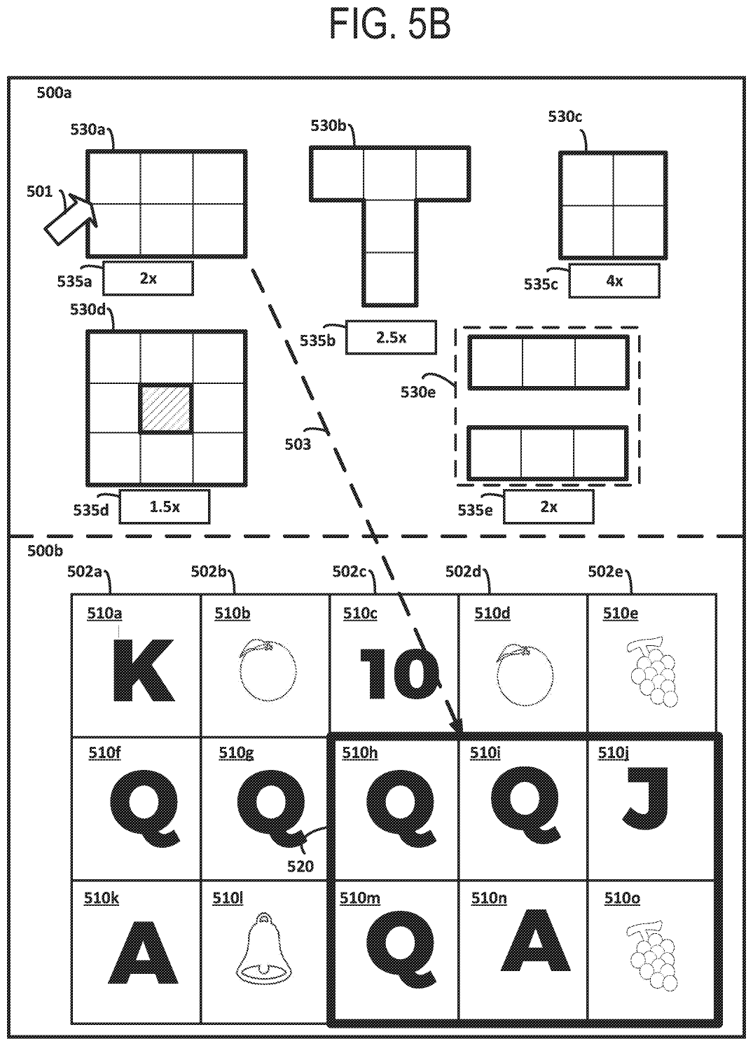

A cluster pattern can be any suitable shape, such as a square, rectangle, circle, triangle, trapezoid, polymino, etc. A few example cluster patterns are illustrated in FIG. 5A in game screen 500a. In some implementations, a size and/or shape of a cluster pattern can match or conform with one or more symbol display areas. In some implementations, the gaming system may include one or more predefined cluster pattern shapes. In some implementations, the gaming system may enable a player to draw, form, or otherwise create one or more cluster patterns shapes. In some implementations, the gaming system may select or otherwise determine a cluster pattern for association with one or more symbol display areas in a game. In some implementations, the gaming system may also determine a position of a cluster pattern in the symbol display areas using one or more different types of criteria. The position of a cluster pattern in the symbol display areas may cause the cluster pattern to be associated with one or more of the symbol display areas. The symbol display areas associated with a cluster pattern may form one or more groupings of symbol display areas (e.g., forming a grouping of symbol display areas that resemble the cluster pattern). In some implementations, the gaming system may use the selected and positioned cluster pattern (e.g., or the grouping of symbol display areas that resemble the cluster pattern) to evaluate displayed symbols in the symbol display areas and within the cluster pattern for one or more winning symbol combinations. The gaming system may provide an award based on such one or more winning symbol combinations.

FIGS. 3A and 3B describe parts of a cluster pattern game related to a video-based gaming system's base or primary game. However, it should be understood that the gaming system may include the cluster pattern game in a spinning reel gaming system's base or primary game or may use the cluster pattern game with a different type of base game or primary game. Furthermore, the gaming system may use the cluster pattern game with a gaming system's bonus game similar to how the cluster pattern game is described as used with a base or primary game. In some implementations, a cluster pattern can be used to selectively triggering a bonus game feature based on one or more symbols being displayed within a grouping of symbol display areas associated with the cluster pattern.

In some implementations, one or more processors (e.g., processor 202) of the gaming system are configured, via instructions stored in a memory device (e.g., memory 204 or a storage system), to perform the operation 300. In block 305, the gaming system receives monetary value via a value acceptor device (e.g., value acceptor 208). In block 310, the gaming system determines a credit balance based on the monetary value received from the player in block 305 at the value acceptor device. In block 315, the gaming system receives a wager for a play of a game from a player via an input device (e.g., player controller 212) using, e.g., the credit balance determined at block 310.

In some implementations, the gaming system allows the player to place a minimum wager, a maximum wager, or any suitable wager amount. In some implementations, the player's wager amount may determine the value of some of the available awards. Depending on the wager amount, the gaming system may also enable the player to select pay lines across displayed symbol positions (e.g., symbol display areas) on reels in a game in which to place wagers. Although in some implementations, the gaming system selects the wagered pay lines automatically based on the player's wager. Wagered pay lines may be referred to herein as active pay lines and may be used in part to determine winning symbol combinations. In some implementations, the gaming system may also use ways pays for evaluating winning symbol combinations. In some implementations, the gaming system determines whether the credit balance determined at block 315 includes enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system with a cash out request. The cash out request may trigger the gaming system to issue a cash out signal to a value dispenser. At block 320, the gaming system updates the credit balance determined at 310 in accordance with the amount wagered at 315.

At block 325, the gaming system receives a request to initiate a play of a base game via the input device. For example, the player may press a spin button on the gaming system to start spinning slot machine reels of the gaming system for a play of the game. In some implementations, a play of a game begins with a wager and activation of a game and the play of the game ends when the base game has completed. In another implementation, one play of a game comprises the processor executing blocks 315-361 and terminating either at block 360 or at block 361 depending on whether the gaming system activates a bonus game feature. In some implementations, block 362 and block 364 are not part of a play of a game. In alternative implementations, block 362 and block 364 are part of a play of a game.

It should be appreciated that reels or slot machine reels used throughout the specification may refer to mechanical reels, electro-mechanical reels, or virtual video reels (where virtual reels strips or no reel strips are used). It should further be appreciated that although many examples illustrated in the specification describe the gaming system in terms of slot machines with reels, other gaming systems may be used, including gaming systems without slot machine reels.

In some implementations, the gaming system may select one or more cluster patterns for association with one or more symbol display areas of the game before or during the game. The cluster patterns can be randomly selected or selected based on some other criteria. In some implementations, the gaming system may select one or more cluster patterns from one or more cluster pattern sets. The gaming system may also determine a position of the selected one or more cluster patterns on a game screen. For a game including symbol display areas, the gaming system may randomly select (or select using other suitable criteria) a position of the selected one or more cluster patterns among the symbol display areas. In some implementations, a position of the selected one or more cluster patterns among the symbol display area may cause one or more symbol display areas to be associated with the selected one or more cluster patterns. It should be appreciated, as will be described below, that one or more cluster patterns can be selected, positioned, and associated with symbol display areas at other times during a play of a game.

For example, the gaming system can randomly select a horizontally oriented rectangular cluster pattern, which is approximately the size of three symbol display areas, from a cluster pattern set having multiple different cluster patterns. In some implementations, the gaming system may also randomly select a position of one or more symbol display areas to associate with the cluster pattern. In some implementations, the gaming system can display an overlay of the rectangular cluster pattern over the associated symbol display areas or otherwise highlight the symbol display areas associated with the rectangular cluster pattern.

At block 330, the gaming system randomly generates, using a random number generator (e.g., random number generator 214) game symbols for at least one reel of the gaming system from a first symbol set.

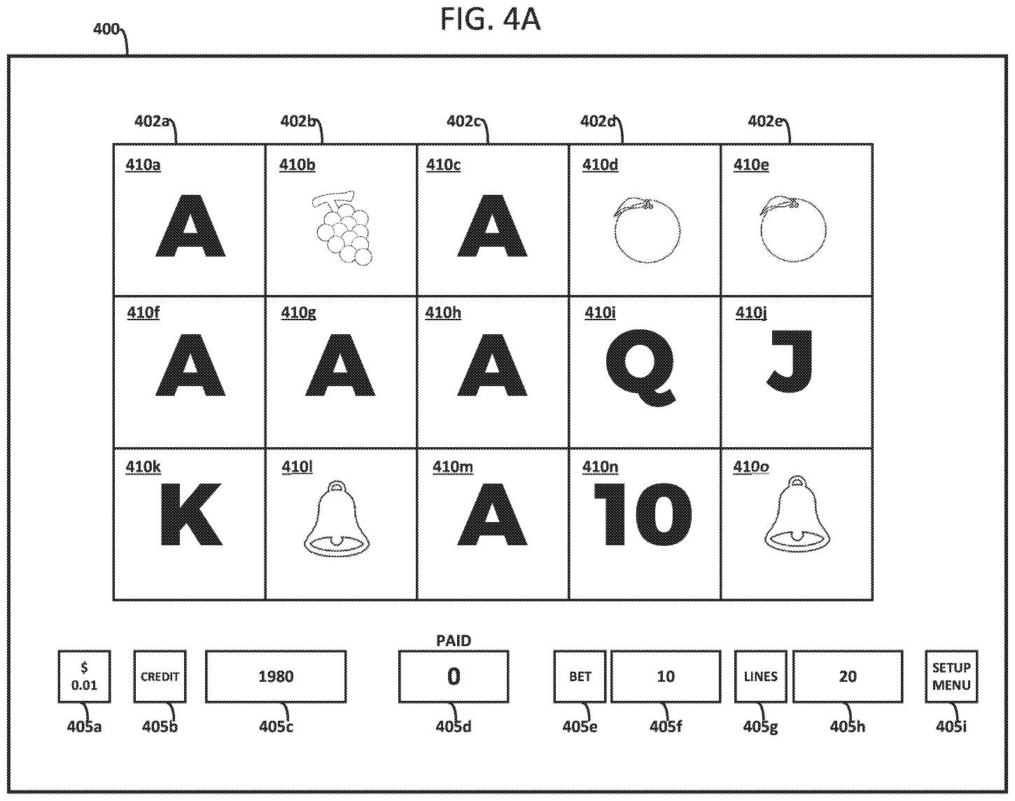

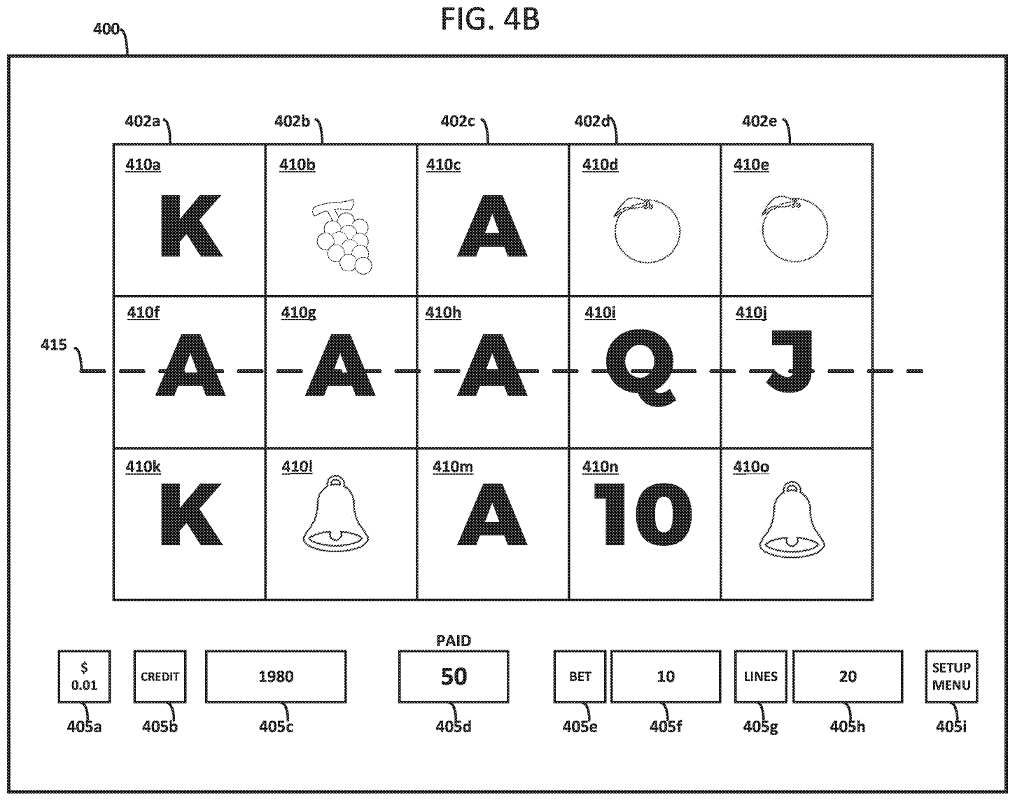

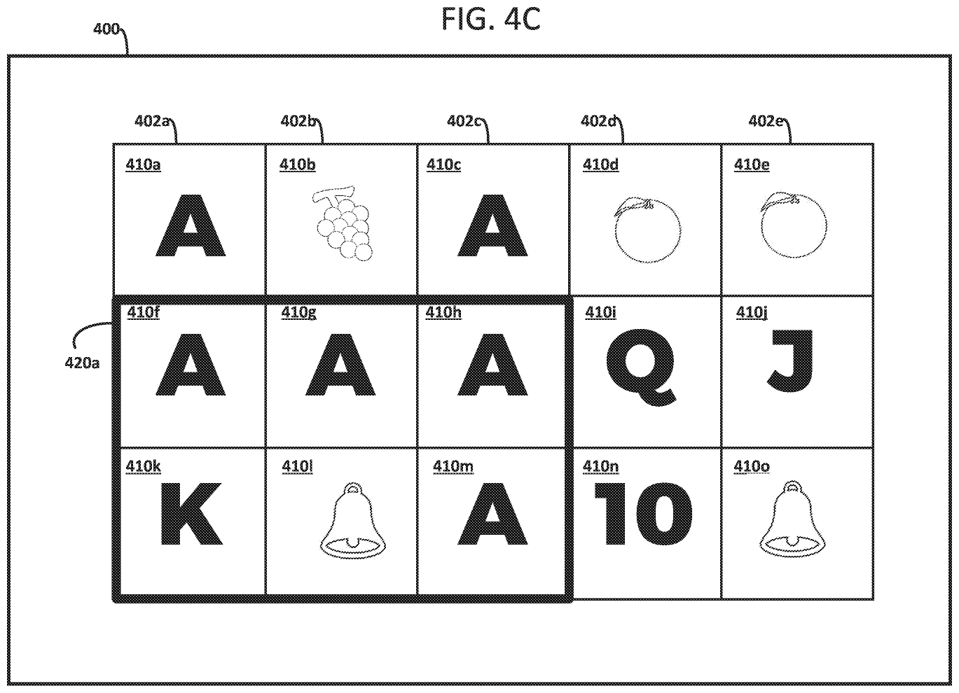

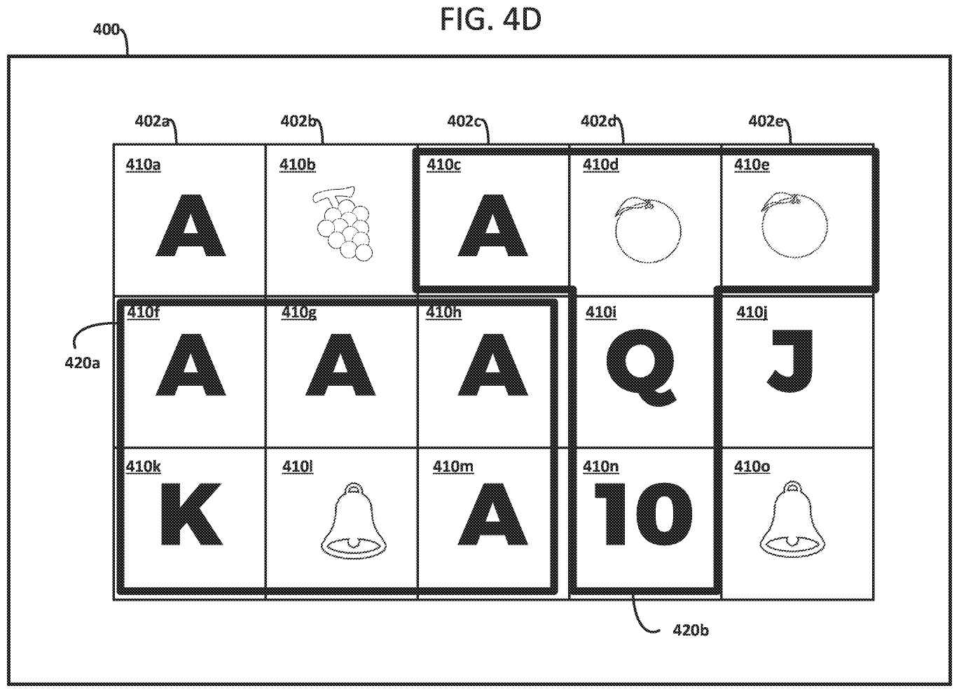

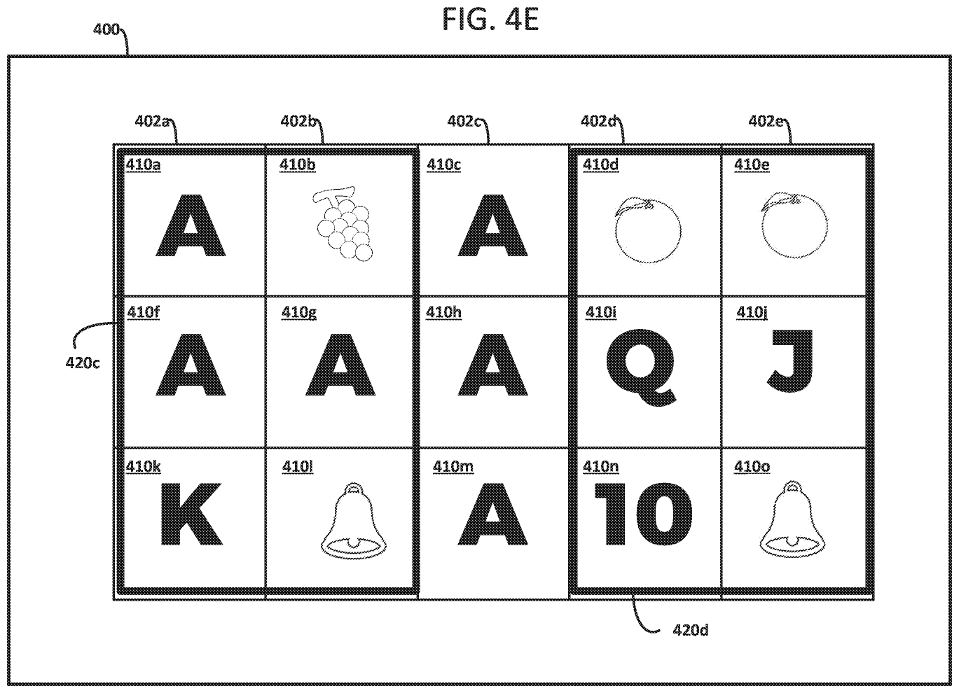

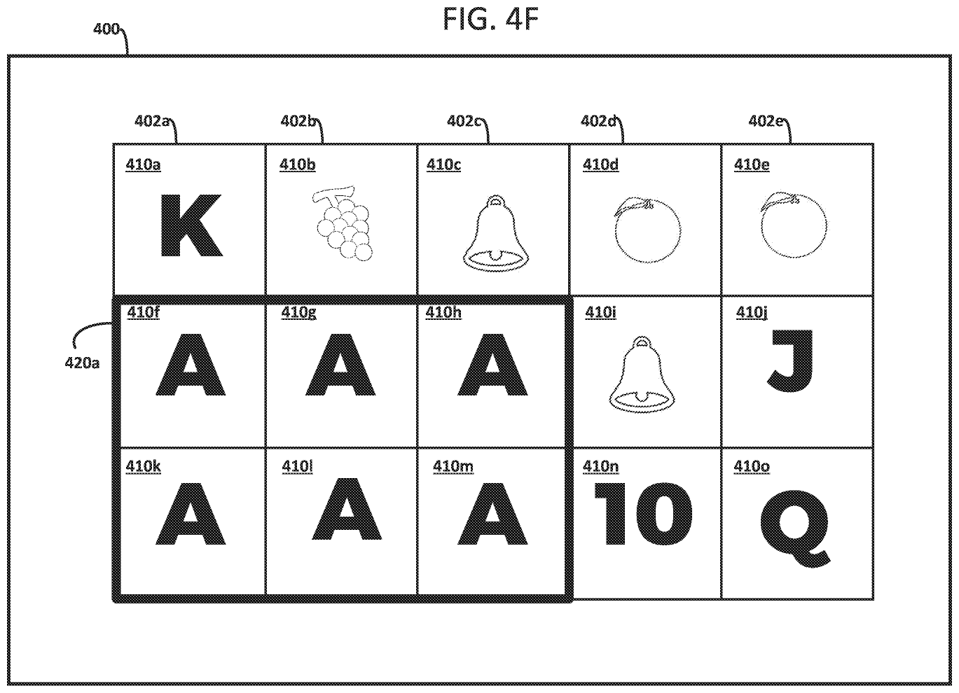

In some implementations, the gaming system may generate symbols for display on at least one reel (e.g., reel 402a in FIG. 4A). In some implementations, the gaming system may generate the symbols for display on a set of reels (e.g., reels 402a-402e in FIG. 4A). In some such implementations, the reels are associated with respective sets of symbols. At block 335, the gaming system causes a display device (e.g., first display device 120) to display the symbols generated at 330. For example, in a gaming system using reels, the gaming system may display the generated symbols in visible symbol display areas of the respective individual reels.

Turning now to FIG. 3B, as indicated by off-page connector A, at block 340, the gaming system evaluates the displayed symbols for winning symbol combinations. The gaming system may also evaluate whether displayed symbols in a grouping of the symbol display areas associated with a cluster pattern results in a win.

In some implementations, gaming system evaluates the displayed symbols across (e.g., across active or wagered pay lines and/or based on ways pays) for winning symbol combinations. In some implementations, the gaming system evaluates the winning symbol combinations based on the pay lines (e.g., pay lines 415 in FIG. 4B) wagered upon by a player, ways pays, scatter symbols, or other suitable evaluation criteria. The gaming system may evaluate the player-selected pay lines, gaming system assigned pay lines, or pay lines assigned as active in some other manner for the play of the game. In some implementations using reels, the gaming system determines an award amount based on winning symbol combinations formed across the reels on active pay lines. For example, if a pay table associated with the gaming system indicated that at least three of the same bar symbols is a winning symbol combination and provides a predetermined award, the gaming system would evaluate the generated and displayed symbols for bar symbols. If the gaming system generated and displayed at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In some implementations, a pay table may indicate that as few as one symbol may be associated with a payout. Alternatively, any suitable two or more symbols may be used to form winning symbol combinations that result in a payout.

Continuing with block 340, the gaming system may evaluate displayed symbols within the grouping of the symbol display areas associated with the cluster pattern. In some implementations, the gaming system may evaluate the displayed symbols associated with the cluster pattern for the presence of one or more winning symbols or winning symbol combinations. For example, the gaming system may determine that the displayed symbols for a grouping of symbol display areas associated with a cluster patter results in a win when at least a threshold quantity (e.g., one or more) or at least a threshold percentage (e.g., at least half) of the symbol display areas for the cluster pattern display a common symbol. As another example, the gaming system may determine that the symbols for a grouping of symbol display areas associated with a cluster patter results in a win when all of the symbol display areas for the cluster pattern display a common symbol. In some implementations, a win can be based on the cluster pattern displaying determined or predetermined quantities of different symbols. The gaming system may include one or more pay tables identifying winning symbol combinations in cluster patterns in some implementations. In some implementations, the gaming system may randomly determine symbol combinations that evaluate as a win in cluster patterns before or during a play of a game.

In some implementations, the gaming system may provide multiple clusters patterns that are associated with different respective groupings of the symbol display areas, and the gaming system may evaluate the respective groupings of the symbol display areas associated with the cluster patterns for the presence of one or more winning symbols or winning symbol combinations. In some implementations, the multiple cluster patterns can overlap one another in the symbol display areas wherein one or more symbol display areas are shared by different cluster patterns.

At block 345, the gaming system may determine one or more awards based on winning symbol combinations (e.g., across wagered pay lines, ways pays, scatter symbols, etc.). The gaming system may also determine one or more awards based on one or more combinations of symbols in the grouping of the symbol display areas associated with cluster pattern, as evaluated in block 340. As noted above, one or more pay tables may define awards that associated with winning symbol combination and/or based on cluster patterns. In some implementations, the awards for the cluster patterns may be determined based on the wager amount, the number of pay lines activated, number of matching symbols, etc. In some implementations, the gaming system may determine that a progressive award is triggered when the symbol display areas associated with the cluster pattern display one or more winning symbols or a particular winning symbol combination (e.g., a threshold of the symbol display areas within the cluster pattern displays an Ace symbol). In some implementations, the awards for a cluster pattern may be determined at least partially based on one or more attributes of the cluster pattern, such as a shape of the cluster pattern, a quantity of the symbol display areas grouped into the cluster pattern, etc.

At block 350, the gaming system updates the player's gaming credit balance in accordance with the payout amount determined at 345. As noted above, the blocks illustrated in FIGS. 3A and 3B can be rearranged in any suitable order. As such, it should be appreciated that the gaming system may update player's gaming credit balance at other suitable times.

In some implementations, the gaming system can enable the cluster patterns feature in a base game as discussed above. In some implementations, the gaming system may enable the availability of the cluster patterns feature in a base game without preconditions or triggering conditions. In some implementations, the gaming system may enable the availability of the cluster patterns feature in a base game based on an occurrence of a triggering condition. The triggering condition can be one or more suitable conditions, alone or in combination, such as, but not limited to, a player's wager amount, a randomly determination to active the cluster patterns feature, generation of certain symbols, etc. The gaming system may enable the cluster patterns feature in a bonus game in a manner similar to a base game.

In some implementations, as indicated in block 360, the gaming system determines whether a bonus game is triggered. In some implementations, the gaming system evaluates the displayed symbols for at least one triggering symbol or for at least one triggering symbol combination of predetermined symbols that triggers the bonus game. It should also be appreciated that in some implementations, events other than generating one or more of a predetermined symbol or other symbol combinations may trigger a bonus game. For example, the gaming system may include or be in communication with a bonus controller, and the bonus controller may randomly determine or determine based on a predetermined triggering event (e.g., a quantity of games played) to trigger or active the bonus game. In some implementations, the gaming system may determine a bonus game is triggered based on evaluating certain triggering symbols or triggering symbol combinations displayed in a cluster pattern associated with the symbol display areas. In some implementations, the gaming system provides the cluster patterns in a bonus game in a manner similar to the manner discussed above with respect to a base game.

Where the gaming system determines that a bonus game is triggered, the gaming system may execute the bonus game at block 361. Alternatively, when the gaming system determines that a bonus game is not triggered, in block 360, operation 300 moves to block 362. In some implementations, as indicated in block 362, the gaming system may receive a request or signal to end game play or “cash out” via an input device of the gaming system (e.g., which would end the gaming session). In such a situation, the gaming system dispenses a value to the player, through a value dispenser, based on the player's gaming credit balance as illustrated in block 364 and operation 300 ends.

If the gaming system processor has not received a signal to end game play (e.g., the player continues a gaming session to play another play of the game) via the player input device, the process of operation 300 returns to block 315, as indicated by off-page connector B. The gaming system may receive, via a player input device, a wager for another play of the game and continue operation 300 from block 315. However, in some implementations, the wager may not be accepted if the player has fewer credits than the player's selected wager amount, as shown in block 315.

FIGS. 4A-4F show screen shots of an implementation of a gaming system game screen illustrating an example of a game with one or more cluster pattern based on video slot machine reels, in accordance with aspects of the present disclosure, for a type of base game. More specifically, FIGS. 4A-4F illustrate screen shots of one implementation of a gaming system displaying video-based slot machine reels and one or more cluster patterns used to obtain awards or to obtain enhanced awards. FIG. 4A illustrates one implementation of a game screen 400 that the gaming system 100 may display on a display device of the gaming system. In some implementations, game screen 400 may be displayed on first display 120 of gaming system 100 illustrated in FIG. 1. However, any other suitable display may be used. The game screen 400 displays a set of a virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game screen 400 is merely representative and may have more or fewer game elements (e.g., reels, symbol display areas, symbols, etc.) shown in the game screen 400. It should also be appreciated that other games may be used for the primary or base game. It should further be appreciated that game screen 400 and associated symbol display areas may be independent of or not associated with video-based slot machine reels.

In some implementations, the reels 402a-402e are each respectively associated with a set of symbols or a symbol set, where each set of symbols includes a number of symbols. The sets of symbols can be associated with the same or different symbols. The sets of symbols may include numbers, letters, geometric figures, symbols, images, character, blank symbols (e.g., the absence of symbols), animations, transparent symbols (e.g., symbols that permits underlying symbols to be visible), or any other suitable graphical depiction. The symbols in the sets of symbols may include pay symbols, special or designated symbols, or other suitable types of symbols.

In FIGS. 4A-4F, the game screen 400 depicts a plurality of symbol display areas (also referred to herein as symbol display positions) 410a, 410b, 410c, 410d, 410e, 410f, 410g, 410h, 410i, 410j, 410k, 410l, 410m, 410n, and 410o. The plurality of symbol display areas can be associated in a manner that provides the appearance of game or slot machine reels. It should also be appreciated that the symbol display areas may not be associated with game reels in some implementations. As illustrated in FIGS. 4A and 4B, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In some implementations, the plurality of symbol display areas that provide the appearance of five game reels may be arranged in a manner that visibly shows three symbol display positions (e.g., symbol display areas) of each of the five game reels (e.g., visible stop positions on the reels). For example, the symbol display areas 410a-410o are each associated with positions on reels 402a-402e, respectively. As shown in FIGS. 4A and 4B, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e. The gaming system may display fewer or more reels in various implementations.

The arrangement illustrated in the implementation of FIGS. 4A and 4B thus creates a visible display area of the reels 402a-402e having three visible symbol positions for each reel. When viewed together, reels 402a-402e appear as a 3-row by 5-column reel array in game screen 400. In other implementations, smaller or larger visible areas of the reels may be displayed. That is, the reels 402a-402e may show fewer or a larger number of visible symbol display areas. In some implementations, some symbol display areas can be hidden to hold generated symbols for use when the reels are nudged. While symbol display areas are illustrated with defined boxes or borders, it should be appreciated that in some implementations, the defined boxes are not visible to the player. It should also be appreciated that in some implementations, the symbol display areas are other shapes or not defined shapes and may not be associated with game elements or objects other than reels.

Reels 402a-402e may display a plurality of symbols that the gaming system generates from the sets of symbols in their respective symbol display areas, as illustrated in FIGS. 4A and 4B. In some implementations, the individual reels may be shown spinning in one direction to simulate slot machine reels. However, it should be appreciated that the reels may be shown spinning in any suitable direction. The reels may also be shown spinning in different directions in some implementations. In some implementations, the gaming system does not depict reels or spinning symbols.

Game screen 400 also includes several information areas and buttons 405a-405i. These information areas and buttons 405a-405i are illustrated in an example configuration and positioning associated with a particular arrangement, but may be arranged in any suitable manner in different implementations. In some implementations, game screen 400 may include more or fewer display areas and buttons 405a-405i than illustrated. Information area 405a illustrates an example value of one credit for the game displayed in game screen 400, and in the example shown in FIGS. 4A and 4B, information area 405a illustrates a value of $0.01. Button 405b illustrates a software button that the player can select to view how many credits the player has accumulated and monetary value of these credits if the player wishes to cease playing (e.g., a product of a value per credit shown in information area 405a and a number of remaining credits shown in information area 405c). Information areas 405c illustrate an example of the amount of the player's available credits. In the example shown in FIGS. 4A and 4B, information area 405c illustrates that the player has 1980 available credits after placing a wager. Information area 405d illustrates the amount of credits a player has won. Because FIG. 4A illustrates an example display associated with a start of a play of a game, the information area 405d shows zero credits have been won during the play of the game.

Button 405e illustrates a software button that the player can select to place a bet or wager. It should be appreciated that the functionality of button 405e may also be replicated or replaced with a hardware button on the gaming system 100. Information area 405f illustrates that the player has selected to wager 10 credits per pay line. Button 405g illustrates a software button that the player can select to determine how many pay lines to wager on. It should be appreciated that the functionality of button 405g may also be replicated or replaced with a hardware button on the gaming system 100. Information area 405h identifies a number of pay lines on which the player chooses to wager, and in the example shown in FIG. 4A, information area 405h indicates that the player selected to wager on 20 pay lines. It should be appreciated that in some implementations, the player does not select a quantity of pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on the play of the game. The gaming system may provide a visual indication of the player's credit balance to the player as discussed above in information area 405c.

To initiate the play of the game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever (not shown). The gaming system may deduct the appropriate credits from the player's credit balance (e.g., in information area 405c) after the wager or at any suitable time. For example, the gaming system may deduct a wager per pay line in information area 405f multiplied by a number of pay lines in information area 405h.

Upon receipt of the player's wager and activation of the game start button, the gaming system may show a display of spinning reels for each of the reels 402a-402e. The spinning may appear to occur in a vertical top to bottom direction or in a vertical bottom to top direction (not shown), or in a combination of vertical directions (not shown). In some implementations, the gaming system randomly generates symbols from the associated sets of symbols for reels 402a-402e, respectively. As noted above, the gaming system may rely on random generation performed by a pseudo RNG, a true RNG, or hardware RNG specifically designed for gaming systems. In some implementations, the gaming system may also update the player's credit meter (information area 405c) to reflect the player's available credit balance. As shown in FIG. 4A, the player's credit meter (information area 405c) was decremented by 200 credits from 2180 to 1980 to reflect a prior 200 credit wager the player placed for the play of the game.

The gaming system displays the generated symbols in symbol display areas 410a-410o, as illustrated in FIGS. 4A-4F. Symbols displayed on reels 402a-402e illustrate the randomly generated symbols from the symbol sets after the reels have stopped spinning. As illustrated in FIGS. 4A-4F, the gaming system randomly generated and displayed symbols in symbol display areas 410a-410o for reels 402a-402e.

In the example illustrated in FIGS. 4A-4D, the gaming system generated and displayed an Ace symbol (“A”) in symbol display areas 410a, 410c, 410f, 410g, 410h, and 410m; an Orange symbol in symbol display areas 410d and 410e; a Grape symbol in symbol display area 410b; a Queen symbol (“Q”) in symbol display area 410i; a Jack symbol (“J”) in symbol display area 410j; a King symbol (“K”) in symbol display area 410k; a Bell symbol in symbol display areas 410l and 410o; and a 10 symbol in symbol display area 410n. It should be appreciated that the displayed symbol combinations are merely for explanatory purposes and the gaming system may randomly generate any suitable combination of symbols based on defined symbol sets associated with the reels 402a-402e.

In some implementations, the gaming system may evaluate the displayed symbols on reels 402a-402e for winning symbol combinations. As noted above, the player may have wagered on one or more pay lines (e.g., such as 20 pay lines shown in information area 405h). In some implementations, at least the active (e.g., the wagered on pay lines) are evaluated for winning symbol combinations. Any suitable number of pay lines may be used to evaluate winning symbol combinations. The gaming system may use other suitable methods of evaluating the displayed symbols for winning symbols or winning symbol combinations (e.g., ways pays, scatter combinations, etc.)

In some implementations, the gaming system may evaluate the generated symbols on reels 402a-402e for triggering symbols or combinations of symbols that trigger the cluster patterns (hereafter referred to as “triggering symbol combinations”). As noted above, the player may have wagered on one or more pay lines (such as 20 pay lines shown in information area 405h). In some implementations, at least the active (e.g., the wagered on pay lines) are evaluated for triggering symbol combinations. Any suitable number of pay lines may be used to evaluate for the triggering symbol combinations.

In some implementations, the gaming system evaluates the displayed symbols for winning symbol combinations before evaluating the reels for triggering symbol combinations that trigger one or more cluster patterns. For example, the gaming system may provide the cluster patterns as an award in the base game, such as when the displayed symbols on reels 402a-402e correspond to one or more of winning symbol combinations. In another example, the gaming system may evaluate the displayed symbols for triggering combinations based on determining that the displayed symbols on reels 402a-402e do not correspond to any of the winning symbol combinations (e.g., one or more cluster patterns may be triggered as a consolation award). In some implementations, the gaming system does not evaluate the displayed symbols for winning symbol combinations until after the reels have been evaluated for triggering symbol combinations that trigger the one or more cluster patterns. For example, the gaming system may first evaluate the generated symbols for triggering symbol combinations and then evaluate the generated symbols for winning symbol combinations when the one or more cluster patterns are not triggered.

In some implementations, the gaming system does not evaluate the displayed symbols for triggering symbol combinations that trigger the cluster patterns. For example, in some implementations, the gaming system may offer cluster patterns without a precondition or a triggering condition. As another example, the gaming system may evaluate the displayed symbols for winning symbol combinations, and the gaming system may determine that the one or more cluster patterns are triggered whenever the displayed symbols correspond to one or more winning symbol combinations (e.g., it is a winning symbol combination, rather than a particular triggering symbol combination that results in the gaming system providing the cluster pattern feature). In other examples, the gaming system may determine that the one or more cluster patterns are triggered and selected based on other factors in addition to or unrelated to the displayed symbols. As noted above in connection with FIGS. 3A and 3B, the gaming system may select a cluster pattern at any suitable time before or during a play of the game (e.g., independent of a triggering symbol combination). For example, the gaming system may determine that one or more cluster patterns are triggered based on receiving a user input (e.g., a user request received by one or more of the buttons) to request one or more cluster patterns. In some implementations, the gaming system may provide one or more cluster patterns when the player wagers on one or more pay lines or when the player places a suitable threshold wager amount (e.g., wagers over $1) for a play of the game. In other examples, the gaming system may include or be in communication with a bonus controller, and the bonus controller may randomly determine or determine based on a predetermined triggering event (e.g., quantity of games played) to trigger or activate the cluster patterns (e.g., select one or more cluster patterns to associate to one or more of the symbol display areas). In some implementations, the gaming system may enable the player to pay or wager to activate the one or more cluster patterns.

In the example shown in FIG. 4B, the gaming system evaluates the displayed symbols for winning symbol combinations and/or triggering symbol combinations along active pay lines. In FIG. 4B, the gaming system may determine that reels with winning symbol combinations were displayed based on three Ace symbols appearing on certain wagered pay lines. For example, pay line 415 was an active pay line, and three Ace symbols were present along the pay line 415 in display areas 410f, 410g, and 410h. The gaming system may also determine that a winning symbol combination was form based on the three Ace symbols displayed in symbol display areas 410f, 410g, and 410m in some implementations.

As also illustrated in FIG. 4B, the gaming system determines a payout amount for the play of the game based on the displayed winning symbol combinations of Ace symbols and an associated pay table (not shown). The gaming system may update the player's gaming credit balance (e.g., 50 credits in 405d) in accordance with the calculated award amount for the winning combination of Ace symbols. In some implementations, the play of the game ends. In some implementations, the gaming system implements the one or more cluster patterns feature (e.g., as described below with respect to FIGS. 4C-4F and 5A-5B) and may provide additional and/or different awards based on the cluster patterns. In some implementations, the gaming system may provide awards based on cluster patterns alone or in combination with the aforementioned awards.

If the gaming system does not provide the cluster patter feature, the player may continue the gaming session (e.g., play another consecutive play of the game) by executing another play of the game (e.g., part of a gaming session). That is, the player may place another wager and start a new play of the game as noted above. However, continued game play is dependent on the number of credits remaining in the player's credit balance. The player may choose to cash out. The player may select an input button associated with a cash out request, where the processor of the gaming system may receive a cash out signal or request. In such an instance, the gaming system provides the player a value based on the player's credit balance using any of the value items discussed above (bills, coins, vouchers, etc.).

As illustrated in FIG. 4C, the gaming system may generate or select and display a cluster pattern around one or more symbol display areas of game screen 400. The gaming system may randomly generate the cluster pattern from one or more sets of cluster patterns, using an RNG. For example, as illustrated in FIG. 4C, the gaming system may generate a cluster pattern 420a having a rectangular shape with a width of three symbol display areas and a height of two symbol display areas, such that cluster pattern 420a is associated with a grouping of six symbol display areas. In the displayed example, cluster pattern 420a is associated with a grouping that includes symbol display areas 410f, 410g, 410h, 410k, 410l, and 410m. While illustrated as appearing later in the game, in some implementations, the gaming system may select and display one or more cluster patterns earlier during the play of the game (e.g., before the symbol have been displayed, before the start of the play of the game, or any other suitable time).

In some implementations, the gaming system may determine a position of a cluster pattern 420a in the symbol display areas based on a random positioning of the cluster pattern, the wager amount, the number of pay lines activated in the base game, etc. In some implementations, the gaming system may determine a position of a cluster pattern 420a in the symbol display areas based on an input received from the player (e.g., received via a player input device 115 included in the control area 114). For example, the gaming system may enable the player to select one or more of the symbol display areas, such as the player selecting symbol display area 410f, for placement of a top corner of a cluster pattern. In some implementations, the gaming system may highlight one or more of the symbol display areas that can accept a cluster pattern and enable the player to select one of such symbol display areas. For example, the gaming system may instruct the player that the player can select any one of symbol display areas 410a, 410b, 410c, 410f, 410g, or 410h for placement of the cluster pattern 420a. Providing the player the ability to select the cluster pattern gives the player the feeling of some control over the outcome of the play of the game.

In FIG. 4C, the gaming system may provide a visual indication of the cluster pattern 420a as applied to a grouping of the symbol display areas 410f, 410g, 410h, 410k, 410l, and 410m. For example, the gaming system may display a border around the grouping of the symbol display areas 410f, 410g, 410h, 410k, 410l, and 410m to form a representation of the cluster pattern. It should be appreciated that the gaming system may provide other visual indications of the cluster pattern by modifying a visual characteristic (e.g., size, brightness, color, etc.) of the displayed symbols associated with the cluster pattern., In another example, the gaming system may output a sound (e.g., via audio speakers 142) when the player contacts or otherwise moves a curser in a display region associated with the grouping of the symbol display areas 410f, 410g, 410h, 410k, 410l, and 410m for the cluster pattern 420a.

In FIG. 4C, the gaming system may evaluate the grouping of the symbol display areas associated with the cluster pattern 420a to determine an award associated with the combination of displayed symbols in the cluster pattern within the symbol display areas 410f, 410g, 410h, 410k, 410l, and 410m. In some implementations, the gaming system may evaluate the displayed symbols associated with the cluster pattern 420a for the presence of one or more winning symbols or winning symbol combinations, and determine an award associated with the winning symbols or winning symbol combinations within the cluster pattern. For example, the gaming system may determine that the player receives an award when at least a threshold quantity (e.g., one or more) or at least a threshold percentage (e.g., at least half) of the symbol display areas within the cluster pattern display a common symbol. In some implementations, the gaming system may determine an award based on this common symbol, a quantity of common symbol displayed in the grouping of the symbol display areas associated with the cluster pattern, etc. For example, the gaming system may determine that the player receives an award for the cluster pattern 420a because the associated grouping of the symbol display areas 410f, 410g, 410h, 410k, 410l, and 410m displays four Ace symbols. It should be appreciated that one or more combinations of different symbols displayed within a cluster pattern can be used to form winning cluster patterns. The gaming system may update the information area 405d (not shown) with the amount of credits a player has won due to the displayed symbols for the cluster pattern 420a. In some implementations, the awards for the cluster patterns may be determined based on the wager amount, the number of pay lines activated, number of matching symbols, etc. In some implementations, an award associated with a cluster pattern is a multiplier or some other suitable award.

In the examples shown in FIGS. 4D and 4E, the gaming system may provide multiple clusters patterns that are associated with respective groupings of the symbol display areas. As shown in FIG. 4D, the gaming system can provide cluster patterns 420a and 420b of different shape and/or size. In the example, shown in FIG. 4D, a first cluster pattern 420a has a rectangular shape and is associated with a grouping of six symbol display areas 410f, 410g, 410h, 410k, 410l, and 410m, whereas the second cluster pattern 420b has a T-shape and is associated with a grouping of five symbol display areas 410c, 410d, 410e, 410i, and 410n. In other examples, the gaming system may provide two or more of a same cluster pattern (e.g., two cluster patterns of similar size and shape, but positioned to include different groupings of the symbol display areas 410a-410o). In the example shown in FIG. 4E, the gaming system may provide multiple cluster patterns 420c and 420d associated with a rectangular shaped grouping of six symbol display areas. For example, the third cluster pattern 420c is associated with a grouping of symbol display areas 420a 410b, 410f, 410g, 410k, and 410l, whereas a fourth cluster pattern 420d is associated with a grouping of six different symbol display areas 420d 410e, 410i, 410j, 410n, and 410p. In some implementations, the gaming system may further evaluate two or more cluster patterns together to determine additional awards. For example, in some implementations, when certain combinations of two or more cluster patterns are displayed together in a certain manner and are winning cluster patterns, the resulting combination of the two or more cluster patterns can provide additional awards over the individual awards associated with individual winning cluster patterns. For example, the gaming system may apply a suitable multiplier (e.g., 2×, 3×, or other suitable award) to the awards of the combination of cluster patterns.

In some implementations, the gaming system may determine positions of the cluster patterns (e.g., cluster patterns 420a, 420b, 420c, and 420d) in the symbol display areas based on a random positioning of the cluster patterns or based on another factor, such as the wager amount, an input from the player, etc. In certain implementations, the gaming system may position the multiple cluster patterns 420a, 420b, 420c, and 420d such that the respective groupings of the symbol display areas associated with the multiple clusters patterns do not overlap each other (e.g., do not include a common symbol display area), as shown in the examples depicted in FIGS. 4D and 4E. In some implementations, the gaming system may position two or more of the multiple clusters patterns to overlap such that the respective associated groupings of two of the symbol display areas include one or more common symbol display areas. For example, the gaming system may overlap clusters patterns to both fit within the symbol display areas, to include certain displayed symbols, based on a received input from the player, etc. The gaming system may determine additional awards when overlapping cluster patterns are winning cluster patterns.

In the example shown in FIG. 4D, the gaming system may evaluate the grouping of the symbol display areas associated with the rectangular cluster pattern 420a, as previously described with respect to FIG. 4C. The gaming system may further evaluate the grouping of the symbol display areas associated with the T-shaped cluster pattern 420b to determine an award associated with the combination of displayed symbols in the symbol display areas 410c, 410d, 410e, 410i, and 410n. For example, the gaming system may determine that the player receives no award for the cluster pattern 420b because a common symbol is not displayed by at least a threshold percentage (e.g., 40%) of the associated grouping of the symbol display areas 410c, 410d, 410e, 410i, and 410n. In example shown in FIG. 4E, the gaming system may evaluate the grouping of the symbol display areas associated with the third cluster pattern 420c to determine an award associated with the combination of displayed symbols in the symbol display areas 420a 410b, 410f, 410g, 410k, and 410l, and may evaluate the fourth cluster pattern 420d to determine an award associated with symbol display areas 420d 410e, 410i, 410j, 410n, and 410p.

In some implementations, the features described herein technologically improves the gaming system by performing selective evaluations of displayed symbols. For example, when evaluating cluster patterns for winning cluster patterns, the gaming system may limit its evaluation of displayed symbols for displayed symbols within symbol display areas of a displayed cluster pattern, rather than evaluating all symbols or including symbols not in cluster patterns in its evaluation for winning cluster patterns. By minimizing its evaluation of displayed symbols within cluster patterns (e.g., for the cluster pattern evaluation portion of a game), the gaming system reduces the amount of symbols it must evaluate, enabling the gaming systems to complete a play of a game more quickly than systems that evaluate all of the displayed symbols. By doing so, in some implementations, the disclosed gaming systems can increase the usage rate of the gaming system by allowing more games to be completed in a given time period (e.g., games per hour) and by reducing power consumed during one or more plays of a game.

Moreover, in some implementations, reducing the amount of displayed symbols that are evaluated to a cluster pattern, reduces processing load and memory consumption of the gaming system. By doing so, implementations of the disclosed gaming system avoid reading and writing certain symbols from memory, which increases the efficiency of the gaming system by conserving processor loading and reduces memory consumption. And, when such efficiency improvements are made and applied to the hundreds or thousands of game evaluations in multiple installations of the gaming system (e.g., multiple devices installed at a casino), implementations of the disclosed gaming system provide casino game operators sizable gains in machine efficiency, which is a technological improvement. It should be appreciated that in some implementations with the technological improvement, the gaming system may still evaluate symbols outside of a cluster pattern for other types winning symbols or winning symbol combinations discussed above.

Returning to FIG. 4E, the gaming system may determine that the player receives an award for the third cluster pattern 420c because a common symbol (e.g., an Ace symbol) is displayed by at least a threshold percentage (e.g., half, or other suitable amount) of the associated grouping of the symbol display areas and does not receive an award for the fourth cluster pattern 420d the because a common symbol is not displayed by at least the threshold percentage (e.g., 50%, or other suitable amount) of the grouping of the symbol display areas. Thus, the gaming system may separately evaluate the displayed symbols associated with the cluster patterns. In other implementations, the gaming system may collectively evaluate the displayed symbols associated with two or more of the cluster patterns (e.g., to determine whether a common symbol is displayed in at least a threshold percentage of the associated groupings of the symbol display areas).

In some implementations, the gaming system may determine that a progressive award is triggered when the symbol display areas associated with a cluster pattern displays one or more winning symbols or a particular winning symbol combination. For example, FIG. 4F illustrates another example having symbol display areas 410a-410o that are similar to the example in FIGS. 4A-4E except that symbol display areas 410k and 410l display Ace symbols. The gaming system may determine a progressive award is triggered for the cluster pattern 420a because, for example, the associated grouping (e.g., the cluster pattern 420a) of the symbol display areas 410f, 410g, 410h, 410k, 410l, and 410m displays a certain threshold (e.g., all symbols or 100 percent, or some other suitable quantity) of a common symbol (e.g., an Ace symbol or other suitable symbol). In other examples, the gaming system may determine whether a progressive award is triggered based on other symbol combinations in a cluster pattern or other factors, such as a wager amount, number of active pay lines, etc. It should be appreciated that in some implementations, the Ace symbols in symbol display areas 410f, 410g, 410h, 410k, 410l, and 410m may also cause the gaming system to provide other awards independent of the cluster pattern (e.g., one or more pay table awards based on active pay lines that include the displayed Ace symbols).

FIGS. 5A and 5B show pictures of a gaming system display illustrating one or more cluster patterns in accordance with aspects of the present disclosure. For the sake of brevity, FIGS. 5A and 5B share features similar to the features already discussed above in connection with FIGS. 3A, 3B, and 4A-4F and such similar feature will not be described again. FIGS. 5A and 5B illustrate screen shots of one implementation of a gaming system that provides one or more cluster patterns. FIGS. 5A and 5B illustrate certain implementation of game screens 500a and 500b that the gaming system 100 may display on a display device of the gaming system. In some implementations, first game display 500a may be displayed on a first display 120 of gaming system 100 and second game display 500b may be displayed on a second display 130 of gaming system 100 illustrated in FIG. 1. However, any other suitable display may be used, such as presenting first game display 500a on a first (e.g., upper) section of the first display 120 and second game display 500b may be displayed on a second (e.g., lower) section of the first display 120. In still other implementations, first game screen 500a and second game screen 500b can be displayed on different gaming systems. For example, first game screen 500a can be displayed on a common display linked to a plurality of different gaming systems that are in communication with the common display and/or with the other different gaming systems. The plurality of different gaming systems may display individual versions of second game screen 500b. The cluster patterns available in first game screen 500a may be made available to all of the different gaming systems. In some implementations, players at the different gaming system may all vie for one or more the cluster patterns in the first game screen 500a (such as in a tournament). A first gaming system of the different gaming systems may obtain one of the cluster patterns available in first game screen 500a when a triggering event that occurs at the first gaming system. The triggering event can be any suitable triggering event and a selection of one of the cluster patterns for the first gaming system may occur as described herein. Once the first gaming system obtains the cluster pattern, the gaming system may use the cluster pattern as discussed herein to provide one or more awards to a player at the first gaming system. In some implementations, as gaming systems obtain the cluster patterns, the cluster patterns may become unavailable for a period of time (e.g., for 1 minute, until a new tournament starts, etc.). In some implementations, the cluster patterns are always available.

As shown in FIGS. 5A and 5B, the first game screen 500a may present one or more sets of cluster pattern candidates 530a-530e of different shapes, sizes, etc. For example, a first cluster pattern candidate 530a has a substantially rectangular shape that includes six symbol display areas. A second cluster pattern candidate 530a has a substantially T-shape that includes five symbol display areas. A third cluster pattern candidate 530c has a substantially square shape that includes four symbol display areas. It should be appreciated, however, that the set of cluster pattern candidate 530a-530e may include cluster pattern candidates of any feasible shape, size, or other characteristics. In other examples, the first game display 500a may present a non-continuous cluster pattern candidate. For instance, a fourth cluster pattern option candidate 530d has a ring shape that includes a grouping of eight symbol display areas and excludes at least one central symbol display area (e.g., such that a symbol displayed in the central symbol display area would not be considered when evaluating a grouping of the symbol display areas associated with the fourth cluster pattern candidate 530d). In other examples, the first game display 500a may present a non-contiguous a cluster pattern candidate. For instance, a fifth cluster pattern option candidate 530e has two parallel rows that include six symbol display areas and exclude symbol display areas provided between the parallel rows of symbol display areas. In some implementations, the cluster pattern candidates displayed in first game screen 500a may be generated and displayed from one or more sets of cluster patterns. In some implementations, the gaming system may randomly select cluster pattern candidates to display in first game screen 500a before or during a play of a game from one or more sets of cluster patterns. In some implementations, the gaming system has a predetermined set of cluster patterns to display in first game screen 500a. In some implementations, different wager amounts may cause the gaming system to select from different sets of cluster pattern candidates. For example, a small wager may cause a gaming system to select cluster pattern candidates for display on the first game screen 500a from cluster pattern sets that result in lower potential awards (or alternatively are associated with harder to obtain winning cluster patterns) than a relative larger wager. In some implementations, the relatively larger wager may cause a gaming system to select cluster pattern candidates for display on the first game screen 500a from cluster pattern sets that result in higher potential awards (or alternatively are associated with easier to obtain winning cluster patterns).

As shown in FIGS. 5A and 5B, the first game screen 500a may include information areas 535a-535e associated with the multiple cluster pattern candidates 530a-530e. As illustrated in FIGS. 5A and 5B, information areas 535a-535e may provide information regarding possible awards associated with the set of cluster pattern candidates 530a-530e. In some implementations, the gaming system may associate the set of cluster pattern candidates with respective different possible awards, and these different awards may be identified in the information areas 535a-535e. For example, the gaming system may determine awards for the set of cluster pattern candidates based on their respective sizes (e.g., quantities of symbol display areas grouped by the cluster pattern candidates), respective shapes, etc. In the example, shown in FIGS. 5A and 5B, the first and fifth cluster pattern candidates 530a and 530e have a size of six symbol display areas and may have an award multiplier of 2×, while smaller second and third cluster pattern candidates 530b and 530c have relatively smaller sizes and larger award multipliers (respectively 2.5× and 4×), and a larger cluster pattern candidate 530c has a relatively larger size and a smaller award multiplier (1.5×). It should be appreciated that these award amounts are provided solely for purposes of example and are not meant to limit the scope of the present application.

In other examples, the information areas 535a-535e may identify other information (not shown) associated with the set of cluster pattern options 530a-530e. For example, the information areas 535a-535e may identify a wager amount, winning likelihood, selection frequency, etc., associated with the set of cluster pattern options 530a-530e. In some implementations, some cluster patterns can be associated with different properties. For example, some cluster patterns may be associated with a property of enabling a player to select a location in the symbol display areas of second game screen 500b to place the cluster pattern (more fully described hereinbelow) while other cluster patterns are associated with random placement in the symbol display areas of second game screen 500b (e.g., players cannot select where to place the cluster pattern). In some implementations, larger wagers may be associated with unlocking different properties of one or more cluster patterns.

Continuing with FIGS. 5A and 5B, the second game screen 500b may depict a plurality of symbol display areas (also referred to herein as symbol display positions) 510a-510o associated with reels 502a-502e. In the displayed example, a King symbol is displayed in symbol display area 510a; an Orange symbol is displayed in symbol display areas 510b and 510d; a Ten symbol is displayed in symbol display areas 510e and 510o; an Ace symbol is displayed in symbol display areas 510k and 510n; a Queen symbol is displayed in symbol display areas 510f, 510g, 510h, 510i, and 510m; a Jack symbol is displayed in symbol display area 510j, and a Bell symbol is displayed in symbol display area 510l. In FIG. 5A, the gaming system may determine that reels with winning symbol combinations were displayed based on three Queen symbols appearing on certain wagered pay lines. For example, the gaming system may determine that pay line 515 is associated with an award since four Queens symbols were present along the display areas 510f, 510g, 510h, and 510i.

Referring to FIG. 5B, in some implementations, a player may select the first cluster pattern shape 530a by manipulating a selection icon 501 to a region of the first game display 500a using, for example, an input device 115. In some implementations, the gaming system enables the player to select cluster patterns using a touch screen interface and drag a selected cluster pattern to a desired location on the symbol display areas. In other implementations, the gaming system may randomly select a cluster pattern from the displayed set of cluster patterns based on a wager amount, the number of pay lines activated, etc. In some implementations, the cluster pattern feature can be made available based on random determination, based on the gaming system receiving a threshold wager, based on how long the player has played on a gaming system, based on the appearance of a trigger symbol or trigger symbol combination, or other based on other suitable determination mechanisms. In some implementations, the gaming system may select one or more cluster patterns for placement on the symbol display areas in second game screen 500b. The selection and placement of multiple cluster patterns can be at substantially the same time, or sequentially.

In some implementations, the gaming system may move the selected cluster pattern (first cluster pattern 530a in FIG. 5B) along arrow 503 to a randomly determined position in the symbol display areas 510a-510o to provide a cluster pattern 520. For example, the gaming system may use the RNG to generate a value for selecting one or more of the symbol display areas 510a-510o and may position the selected cluster in the selected one or more of the symbol display areas 510a-510o. In some implementations, the gaming system may position the selected cluster pattern in the selecting one of the symbol display areas 510a-510o based on the wager amount, the number of pay lines activated in the base game, etc. In some implementations, the gaming system may select a position for the cluster pattern such that a winning combination of symbols is included in the grouping of the symbol display areas associated with the cluster pattern. In some implementations, the gaming system may reposition the cluster pattern to associate the cluster pattern with a different grouping of symbol display areas based on an input received from the player, another wager by the player, based on an occurrence of a symbol (e.g., a symbol designated as a move symbol) in the grouping of the symbol display areas associated with the cluster pattern, etc. While the illustrated implementations depict selecting a cluster pattern after the displayed symbols have been evaluated for winning symbol combination using other evaluation techniques, it should be appreciate that the cluster pattern can be selected and displayed for the symbol display area before other award evaluations, before symbols are generated, before generated symbols are displayed in the symbol display area, and/or before the play of the game.

In FIG. 5B, the gaming system may evaluate the grouping of the symbol display areas associated with position of the generated cluster pattern 520 (corresponding in size and shape to the selected cluster pattern candidate 530a) to determine an award associated with the combination of displayed symbols in the grouping of symbol display areas 510h, 510i, 510i, 510m, 510n, and 510o. For example, the gaming system may determine that the player receives an award when at least a threshold quantity (e.g., three or more) or at least a threshold percentage (e.g., at least half) of the symbol display areas within the cluster pattern display a Queen symbol. Thus, as illustrated in FIG. 5B, the gaming system may determine that symbols generated in cluster pattern 520 are associated with an award and the gaming system may provide the award to the player.

Based on the forgoing description, it should be appreciated that a gaming system and method with improvements to game outcomes by providing one or more cluster patterns creates new and very exciting ways for a player to obtain improved winnings with a potential to earn greater awards. Such a potential to earn greater awards creates a greatly improved sense of anticipation for players.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a cabinet;
a processor;
a display device supported by the cabinet;
an input device supported by the cabinet;
a value acceptor supported by the cabinet;
a value dispenser supported by the cabinet;
a memory device that stores a plurality of instructions which, when executed by the processor, cause the processor to:
establish a credit balance based on a monetary value received by the value acceptor;
decrease the credit balance by a wager amount received via the input device;
randomly generate a plurality of symbols;
display, on the display device, the plurality of symbols in a plurality of symbol display areas;
randomly select a cluster pattern;
display, on the display device, the cluster pattern associated with a grouping of one or more of the symbol display areas;
evaluate the plurality of symbols for winning symbol combinations;
determine a first award corresponding to a winning symbol combination;
evaluate symbols displayed in the grouping of one or more of the symbol display areas associated with the cluster pattern for winning symbol combinations;
determine a second award corresponding to the symbols displayed in the grouping of one or more of the symbol display areas associated with the cluster pattern;
display the second award;
increase the credit balance by the first award and the second award;
issue value from a value dispenser based on the credit balance upon receipt of a cash out request.

2. The gaming system of claim 1, wherein the plurality of instructions further cause the processor to:
evaluate the plurality of symbols for triggering symbol combinations, wherein the cluster pattern is selected when the plurality of symbols include one or more of the triggering symbol combinations.

3. The gaming system of claim 1, wherein the cluster pattern is a first cluster pattern and is associated with a first grouping of the symbol display areas,
wherein the processor is further to:
display, on the display device, a second cluster pattern associated with a second grouping of one or more of the symbol display areas, and
further determine the second award based on symbols displayed in the second grouping of the symbol display areas associated with the second cluster pattern.

4. The gaming system of claim 3, wherein the first cluster pattern and the second cluster pattern differ in at least one of size or shape.

5. The gaming system of claim 3, wherein the first cluster pattern and the second cluster pattern share a common shape and a common size and are displayed in different locations of the plurality of symbol display areas.

6. The gaming system of claim 1, wherein the second award is determined based on a size of the cluster pattern.

7. The gaming system of claim 1, wherein the second award is determined based on whether at least a threshold quantity of the grouping of one or more of the symbol display areas associated with the cluster pattern display a common symbol.

8. The gaming system of claim 1, wherein the second award includes a progressive award when at least a threshold quantity of the grouping of one or more of the symbol display areas associated with the cluster pattern display a particular symbol.

9. The gaming system of claim 1, wherein the processor is further to select the cluster pattern from a set of cluster patterns having different sizes and shapes.

10. The gaming system of claim 9, wherein the processor is further to select the cluster pattern from the set of cluster patterns based on a received user input.

11. The gaming system of claim 9, wherein the processor is further to randomly position the cluster pattern in the plurality of symbol display areas.

12. A method of operating a gaming system, the method comprising:
receiving, by a monetary value acceptor, a monetary value;
establishing, by a processor of the gaming system, a credit balance based at least in part on the received monetary value;
accepting, from an input device in a housing of the gaming system, a wager amount;
decreasing, by the processor, the credit balance by the wager amount;
randomly generating a plurality of symbols;
displaying, on the display device, the plurality of symbols in a plurality of symbol display areas;
randomly selecting a cluster pattern;
displaying, on the display device, the cluster pattern associated with a grouping of one or more of the symbol display areas;
evaluating the plurality of symbols for winning symbol combinations;
determining a first award corresponding to a winning symbol combination;
evaluating symbols displayed in the grouping of one or more of the symbol display areas associated with the cluster pattern for winning symbol combinations;
determining a second award corresponding to symbols displayed in the grouping of one or more of the plurality of symbol display areas associated with the cluster pattern; and
display the second award;
increasing the credit balance by the first award and the second award;
issuing value from a value dispenser based on the credit balance upon receipt of a cash out request.

13. The method of claim 12, wherein the cluster pattern is a first cluster pattern and is associated with a first grouping of the plurality of symbol display areas,
wherein method further comprises:
displaying, on the display device, a second cluster pattern associated with a second grouping of one or more of the plurality of symbol display areas, wherein the second award is further determined based on symbols displayed in the second grouping of the symbol display areas associated with the second cluster pattern.

14. The method of claim 13, wherein the first cluster pattern and the second cluster pattern differ in at least one of size or shape.

15. The method of claim 12, wherein the second award is determined based on a size of the cluster pattern.

16. The method of claim 12, wherein the second award is determined based on whether at least a threshold quantity of the grouping of one or more of the plurality of symbol display areas associated with the cluster pattern displays a common symbol.

17. The method of claim 12, wherein the selecting the cluster pattern further comprising selecting the cluster pattern from a set of cluster patterns having different sizes and shapes.

18. The method of claim 12, further comprising:
randomly positioning the cluster pattern in the plurality of symbol display areas.

19. A non-transitory computer-readable storage medium having machine instructions stored therein, the instructions being executable by a processor to cause the processor to:
establish a credit balance based at least in part on a monetary value received by a value acceptor of a gaming device;
place a wager following receipt of a wager input via an input device;
decrease the credit balance by the wager;
randomly generate a plurality of symbols;
display, on a display device, the plurality of symbols in a plurality of symbol display areas;
randomly select a cluster pattern;
display, on the display device, the cluster pattern associated with a grouping of one or more of the symbol display areas;
evaluate the plurality of symbols for winning symbol combinations;
determine a first award corresponding to a winning symbol combination, the credit balance being increased by the first award;
evaluate symbols displayed in the grouping of one or more of the symbol display areas associated with the cluster pattern for winning symbol combinations;
determine a second award corresponding to symbols displayed in the grouping of one or more of the plurality of symbol display areas associated with the cluster pattern, the credit balance being increased by the second award; and
issue value from a value dispenser based on the credit balance upon receipt of a cash out request.

20. The non-transitory computer-readable storage medium of claim 19 ,wherein the instructions further cause the processor to:
select the cluster pattern from a set of cluster patterns having different sizes and shapes; and
determine a position for the cluster pattern in the plurality of symbol display areas.
